(19) United States
(12) Patent Application Publication
(10) Pub. No.: US 2024/0344574 A1
(43) Pub. Date: Oct. 17, 2024

(54) RETURN SPRING AND DISC BRAKE

(71) Applicant: Hitachi Astemo, Ltd., Hitachinaka-shi, Ibaraki (JP)

(72) Inventors: Khai Piau LIM, Hitachinaka-shi (JP); Shinji SUZUKI, Hitachinaka-shi (JP)

(21) Appl. No.: 18/683,079

(22) PCT Filed: Sep. 12, 2022
(86) PCT No.: PCT/JP2022/034026

§ 371 Date: Feb. 12, 2024

(30) Foreign Application Priority Data
Sep. 22, 2021 (JP) 2021-154447

(51) Int. Cl. F16D 65/097; F16D 127/02

(52) U.S. Cl. CPC F16D 65/097; F16D 2127/02

(57) ABSTRACT

A return spring includes a fixing part (100) configured to be fixed to a friction pad (8), a first extension part (101) formed in a plate shape and extending from the fixing part (100) in a direction away from the friction pad (8), a second extension part (102) formed in a plate shape and extending from the first extension part (101) in a direction of pressing the friction pad (8), a contact part (103) formed in a plate shape and extending from the second extension part (102) to come into contact with a carrier (5) attached to a non-rotating portion of a vehicle, edge portions which are surfaces each extending in a plate thickness direction of the first extension part (101), the second extension part (102), and the contact part (103), and a cover part (104, 105) covering at least a part of the edge portions.

### TECHNICAL FIELD

The present invention relates to a return spring and a disc brake.

Priority is claimed on Japanese Patent Application No. 2021-154447 filed on Sep. 22, 2021, the content of which is incorporated herein by reference.

### BACKGROUND ART

In disc brakes, there is one that uses a return spring that is integrally formed by punching out a steel plate having spring properties and then bending it using a method such as press working (for example, see Patent Document 1).

### CITATION LIST

### Patent Document

[Patent Document 1]
Japanese Unexamined Patent Application, First Publication No. 2014-196829

### SUMMARY OF INVENTION

### Technical Problem

When maintenance is performed on a disc brake, there has been a likelihood of a decrease in maintainability due to fingers getting caught on an edge portion of the return spring or the like.

An objective of the present invention is to provide a return spring and a disc brake in which maintainability can be improved.

### Solution to Problem

According to a first aspect of the present invention, a return spring includes a fixing part configured to be fixed to a friction pad, a first extension part formed in a plate shape and extending from the fixing part in a direction away from the friction pad, a second extension part formed in a plate shape and extending from the first extension part in a direction of pressing the friction pad, a contact part formed in a plate shape and extending from the second extension part to come into contact with a carrier attached to a non-rotating portion of a vehicle, edge portions which are surfaces each extending in a plate thickness direction of the first extension part, the second extension part, and the contact part, and a cover part covering at least a part of the edge portions.

According to a second aspect of the present invention, a disc brake includes a friction pad, and a return spring having a fixing part fixed to a friction pad, a first extension part formed in a plate shape and extending from the fixing part in a direction away from the friction pad, a second extension part formed in a plate shape and extending from the first extension part in a direction of pressing the friction pad, a contact part formed in a plate shape and extending from the second extension part to come into contact with a carrier attached to a non-rotating portion of a vehicle, edge portions which are surfaces each extending in a plate thickness direction of the first extension part, the second extension part, and the contact part, and a cover part covering at least a part of the edge portions.

### Advantageous Effects of Invention

According to the present invention, it is possible to improve maintainability.

### BRIEF DESCRIPTION OF DRAWINGS

FIG. 1 is a plan view illustrating a disc brake according to a first embodiment.

FIG. 2 is a perspective view illustrating a carrier, an outer friction pad, and a return spring of the disc brake according to the first embodiment.

FIG. 3 is a plan view illustrating the carrier, the outer friction pad, and the return spring of the disc brake according to the first embodiment.

FIG. 4 is a perspective view illustrating the outer friction pad and the return spring of the disc brake according to the first embodiment.

FIG. 5 is a plan view illustrating the outer friction pad and the return spring of the disc brake according to the first embodiment.

FIG. 6 is a front view illustrating the outer friction pad and the return spring of the disc brake according to the first embodiment.

FIG. 7 is a perspective view illustrating the return spring of the first embodiment.

FIG. 8 is a perspective view illustrating the return spring of the first embodiment.

FIG. 9 is a front view illustrating the return spring of the first embodiment.

FIG. 10 is a cross-sectional view along line X-X in FIG. 9 illustrating the return spring of the first embodiment.

FIG. 11 is a perspective view illustrating a return spring of a second embodiment.

FIG. 12 is a perspective view illustrating the return spring of the second embodiment.

FIG. 13 is a front view illustrating the return spring of the second embodiment.

FIG. 14 is a cross-sectional view along line XIV-XIV in FIG. 13 illustrating the return spring of the second embodiment.

FIG. 15 is a perspective view illustrating a return spring of a third embodiment.

FIG. 16 is a perspective view illustrating the return spring of the third embodiment.

FIG. 17 is a front view illustrating the return spring of the third embodiment.

FIG. 18 is a cross-sectional view along line XVIII-XVIII in FIG. 17 illustrating the return spring of the third embodiment.

FIG. 19 is a perspective view illustrating a return spring of a fourth embodiment.

FIG. 20 is a front view illustrating the return spring of the fourth embodiment.

FIG. 21 is a cross-sectional view along line XXI-XXI in FIG. 20 illustrating the return spring of the fourth embodiment.

FIG. 22 is a perspective view illustrating a return spring of a fifth embodiment.

FIG. 23 is a front view illustrating the return spring of the fifth embodiment.

FIG. 24 is a cross-sectional view along line XXIV-XXIV in FIG. 23 illustrating the return spring of the fifth embodiment.

FIG. 25 is a perspective view illustrating a return spring of a sixth embodiment.

FIG. 26 is a front view illustrating the return spring of the sixth embodiment.

FIG. 27 is a cross-sectional view along line XXVII-XXVII in FIG. 26 illustrating the return spring of the sixth embodiment.

FIG. 28 is a perspective view illustrating a carrier, an inner friction pad, an outer friction pad, and an inner return spring of a disc brake of a seventh embodiment.

FIG. 29 is a rear view illustrating the carrier, the inner friction pad, and the inner return spring of the disc brake of the seventh embodiment.

FIG. 30 is cross-sectional view along line XXX-XXX of FIG. 29 illustrating the carrier, the inner friction pad, the outer friction pad, the inner return spring, and an outer return spring of the disc brake of the seventh embodiment.

FIG. 31 is a perspective view illustrating the return spring of the seventh embodiment.

FIG. 32 is a perspective view illustrating the return spring of the seventh embodiment.

FIG. 33 is a plan view illustrating the return spring of the seventh embodiment.

FIG. 34 is a bottom view illustrating the return spring of the seventh embodiment.

FIG. 35 is a front view illustrating the return spring of the seventh embodiment.

### DESCRIPTION OF EMBODIMENTS

### First Embodiment

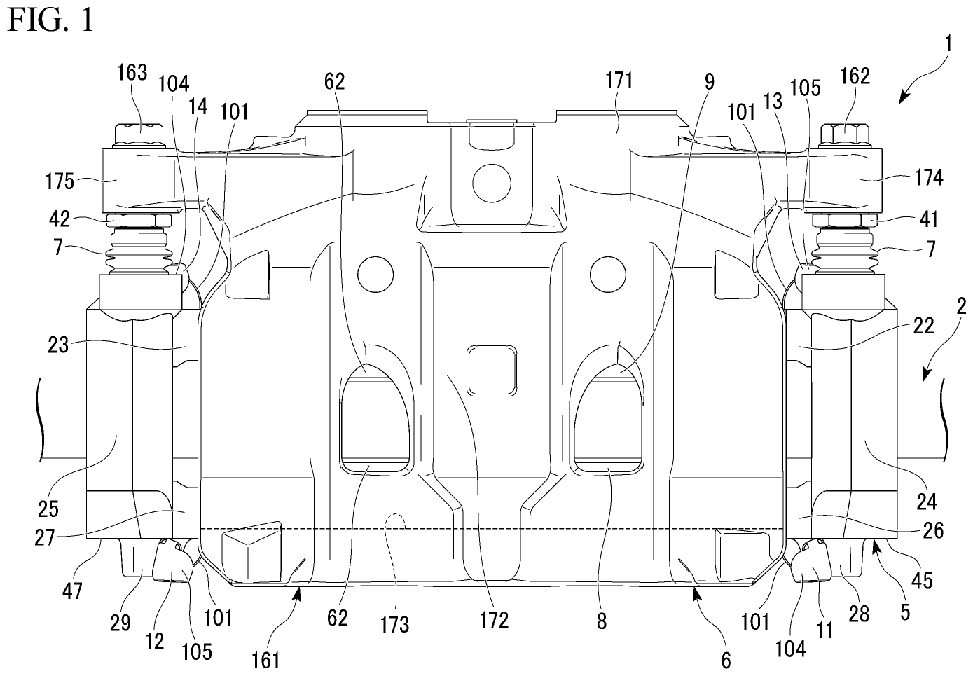

A first embodiment will be described below with reference to FIGS. 1 to 10. A disc brake 1 of the first embodiment is for a vehicle such as an automobile and applies a braking force to a vehicle. Specifically, the disc brake 1 is for a four-wheeled vehicle.

As illustrated in FIG. 1, the disc brake 1 brakes a vehicle by stopping rotation of a disc-shaped disc 2 that rotates together with a wheel (not illustrated).

The disc brake 1 includes a carrier 5, a caliper 6, a pair of boots 7, a pair of friction pads 8 and 9, and four return springs 11, 12, 13, and 14.

Hereinafter, a central axis of the disc 2 is referred to as a disc axis. A direction in which the disc axis extends is referred to as a disc axial direction. A radial direction of the disc 2 is referred to as a disc radial direction. A circumferential direction, that is, a rotation direction of the disc 2 within the carrier 5 and caliper 6 is referred to as a disc rotation direction. A center side of the disc 2 in the disc radial direction is referred to as a disc radially inner side. A side opposite to the center of the disc 2 in the disc radial direction is referred to as a disc radially outer side. A center side in the disc rotation direction within the carrier 5 and caliper 6 is referred to as a disc rotation direction inward side. A side opposite to the center in the disc rotation direction within the carrier and caliper 6 is referred to as a disc rotation direction outward side. A disc radial line extending in the disc radial direction through the center in the disc rotation direction of the carrier 5 and caliper 6 when not braking and the disc axis is referred to as a radial reference line. The radial reference line is orthogonal to the disc axis. An outer side in a vehicle width direction of the vehicle in which the disc brake 1 is provided is referred to as an outer side, and an inner side in the vehicle width direction is referred to as an inner side.

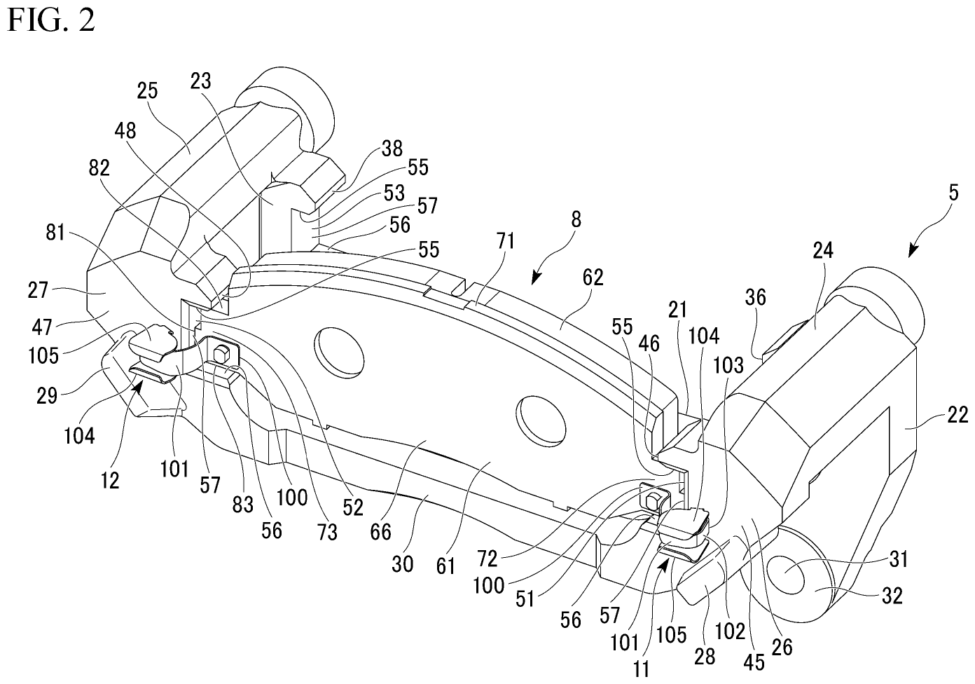

The carrier 5 is an integrally molded product seamlessly formed by casting. As illustrated in FIG. 2, the carrier 5 includes an inner beam part 21, a pair of inner wall parts 22 and 23, a pair of pin insertion parts 24 and 25, a pair of outer wall parts 26 and 27, a pair of outer protruding parts 28 and 29, and an outer beam part 30. The carrier 5 has a mirror-symmetrical shape.

In the carrier 5, the inner beam part 21 is attached to a non-rotating portion of the vehicle. The inner beam part 21 is disposed on one side of the disc 2 in the disc axial direction and is attached to the non-rotating portion of the vehicle. Here, the non-rotating portion of the vehicle to which the carrier 5 is attached is disposed on the inner side with respect to the disc 2. The inner beam part 21 attached to the non-rotating portion is also disposed on the inner side with respect to the disc 2. In the following description, the carrier 5 will be described with it attached to the non-rotating portion of the vehicle.

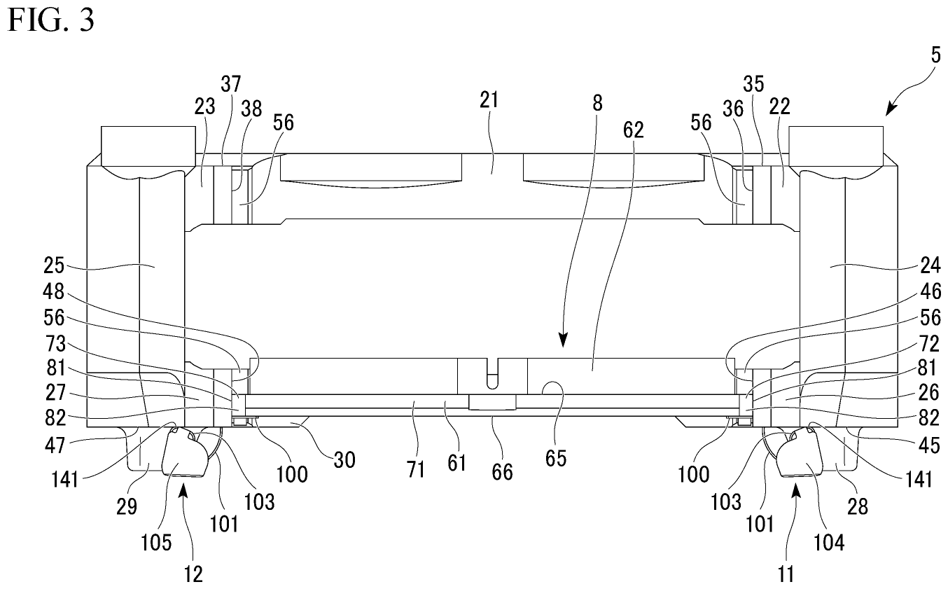

The inner beam part 21 extends in one direction as illustrated in FIG. 3, and is disposed to extend in the disc rotation direction. As illustrated in FIG. 2, a pair of attachment boss parts 32 (only one is illustrated) each having an attachment hole 31 (only one is illustrated) extending in the disc axial direction are provided in the inner beam part 21 on both sides in the disc rotation direction. In the inner beam part 21, the pair of attachment boss parts 32 are attached to the non-rotating portion of the vehicle with attachment bolts screwed into the attachment holes 31.

In the pair of inner wall parts 22 and 23, one inner wall part 22 extends to the disc radially outer side from an end portion on one side of the inner beam part 21 in the disc rotation direction. Also, in the pair of inner wall parts 22 and 23, the other inner wall part 23 extends to the disc radially outer side from an end portion of the inner beam part 21 on a side opposite to the inner wall part 22 in the disc rotation direction.

Hereinafter, in a direction connecting the pair of inner wall parts 22 and 23 that is the same as the disc rotation direction, the inner wall part 22 side will be referred to as a disc rotation direction first side, and the inner wall part 23 side will be referred to as a disc rotation direction second side. The disc rotation direction first side and the disc rotation direction second side are opposite sides in the disc rotation direction. Similarly to the inner beam part 21, the pair of inner wall parts 22 and 23 are disposed on the inner side with respect to the disc 2 as illustrated in FIG. 1.

As illustrated in FIG. 3, the inner wall part 22 has a surface portion 35 facing the inner side on the inner side thereof. The surface portion 35 has a planar shape extending perpendicular to the disc axis. The inner wall part 22 has an inner surface portion 36 facing the disc rotation direction inward side on the disc rotation direction inward side thereof. The inner surface portion 36 extends along the disc axis and along the radial reference line.

The inner wall part 23 has a surface portion 37 facing the inner side on the inner side thereof. The surface portion 37 has a planar shape extending perpendicular to the disc axis. The surface portion 35 and the surface portion 37 are disposed on the same plane. The inner wall part 23 has an inner surface portion 38 facing the disc rotation direction inward side on the disc rotation direction inward side thereof. The inner surface portion 38 extends along the disc axis and along the radial reference line.

As illustrated in FIG. 2, one pin insertion part 24 of the pair of pin insertion parts 24 and 25 is connected to an end portion on the disc radially outer side of the inner wall part 22 on the disc rotation direction first side. The pin insertion part 24 extends to the outer side with respect to the inner wall part 22 in the disc axial direction, and also protrudes to the inner side. A portion of the pin insertion part 24 extending to the outer side from the inner wall part 22 straddles an outer circumferential side of the disc 2 as illustrated in FIG. 1.

Also, as illustrated in FIG. 2, the other pin insertion part 25 of the pair of pin insertion parts 24 and 25 is connected to an end portion on the disc radially outer side of the inner wall part 23 on the disc rotation direction second side. The pin insertion part extends to the outer side with respect to the inner wall part 23 in the disc axial direction, and also protrudes to the inner side. A portion of the pin insertion part 25 protruding to the outer side from the inner wall part 23 straddles an outer circumferential side of the disc 2 as illustrated in FIG. 1.

A pin insertion hole (not illustrated) extending in the disc axial direction is formed in each of the pair of pin insertion parts 24 and 25. The pin insertion hole (not illustrated) of the pin insertion part 24 is formed from an end surface on the inner side of the pin insertion part 24 to an intermediate position inside the pin insertion part 24. The pin insertion hole (not illustrated) of the pin insertion part 25 is formed from an end surface on the inner side of the pin insertion part 25 to an intermediate position inside the pin insertion part 25.

A slide pin 41 of the caliper 6 on the disc rotation direction first side is slidably fitted into the pin insertion hole (not illustrated) of the pin insertion part 24 of the carrier 5. A slide pin 42 of the caliper 6 on the disc rotation direction second side is slidably fitted into the pin insertion hole (not illustrated) of the pin insertion part 25. Thereby, the carrier 5 supports the caliper 6 to be slidable in the disc axial direction at the pair of pin insertion parts 24 and 25 thereof. In other words, the caliper 6 is provided on the carrier 5 to be displaceable in the disc axial direction.

As illustrated in FIG. 2, one outer wall part 26 of the pair of outer wall parts 26 and 27 extends to the disc radially inner side from the pin insertion part 24 on the disc rotation direction first side. The outer wall part 26 extends to the disc radially inner side from an end portion of the pin insertion part 24 on a side opposite to the inner wall part 22, that is, on the outer side.

The other outer wall part 27 of the pair of outer wall parts 26 and 27 extends to the disc radially inner side from the pin insertion part 25 on the disc rotation direction second side. The outer wall part 27 extends to the disc radially inner side from an end portion of the pin insertion part 25 on a side opposite to the inner wall part 23, that is, on the outer side.

The pair of outer wall parts 26 and 27 are disposed on the outer side with respect to the disc 2 as illustrated in FIG. 1.

As illustrated in FIG. 2, the outer wall part 26 has a surface portion 45 facing the outer side on the outer side thereof. The surface portion 45 has a planar shape extending perpendicular to the disc axis. The outer wall part 26 has an inner surface portion 46 facing the disc rotation direction inward side on the disc rotation direction inward side thereof. The inner surface 46 extends along the disc axis and along the radial reference line.

The outer wall part 27 has a surface portion 47 facing the outer side on the outer side thereof. The surface portion 47 has a planar shape extending perpendicular to the disc axis. The surface portion 45 and the surface portion 47 are disposed on the same plane. The outer wall part 27 has an inner surface portion 48 facing the disc rotation direction inward side on the disc rotation direction inward side thereof. The inner surface 48 extends along the disc axis and along the radial reference line.

One outer protruding part 28 of the pair of outer protruding parts 28 and 29 protrudes to the outer side from the surface portion 45 of the outer wall part 26 on the disc rotation direction first side. The outer protruding part 28 protrudes to the outer side from an end edge portion of the surface portion 45 of the outer wall part 26 on the disc rotation direction outward side and on the disc radially inner side. The outer protruding part 28 extends in the disc radial direction at a position of an end edge portion of the surface portion 45 on the disc rotation direction outward side and on the disc radially inner side. The outer protruding part 28 is inclined with respect to the radial reference line so that it becomes further away from the radial reference line toward the disc radially outer side.

The other outer protruding part 29 of the pair of outer protruding parts 28 and 29 protrudes to the outer side from the surface portion 47 of the outer wall part 27 on the disc rotation direction second side. The outer protruding part 29 protrudes to the outer side from an end edge portion of the surface portion 47 of the outer wall part 27 on the disc rotation direction outward side and on the disc radially inner side. The outer protruding part 29 extends in the disc radial direction at a position of an end edge portion of the surface portion 47 on the disc rotation direction outward side and on the disc radially inner side. The outer protruding part 29 is inclined with respect to the radial reference line so that it becomes further away from the radial reference line toward the disc radially outer side.

The outer beam part 30 extends in the disc rotation direction. The outer beam part 30 connects end portions of the pair of outer wall parts 26 and 27 on the disc radially inner side and on the disc rotation direction inward side. The outer beam part 30 is disposed on the outer side with respect to the disc 2 similarly to the pair of outer wall parts 26 and 27.

As described above, the carrier 5 is disposed to straddle the outer circumferential side of the disc 2 in the disc axial direction and is attached to the non-rotating portion of the vehicle. The inner beam part 21 and the pair of inner wall parts 22 and 23 are disposed on the inner side of the carrier 5 which is the attachment side to the non-rotating portion of the vehicle. The pair of outer wall parts 26 and 27 and the outer beam part 30 are disposed on the outer side of the carrier 5 which is a side opposite to the inner side.

A recessed part 51 is formed at a portion of the outer wall part 26 in the disc rotation direction inward side. The recessed part 51 is recessed from the inner surface portion 46 of the outer wall part 26 on the disc rotation direction inward side toward the disc rotation direction outward side. The recessed part 51 penetrates the outer wall part 26 in the disc axial direction.

A recessed part 52 is formed at a portion of the outer wall part 27 in the disc rotation direction inward side. The recessed part 52 is recessed from the inner surface portion 48 of the outer wall part 27 on the disc rotation direction inward side toward the disc rotation direction outward side. The recessed part 52 penetrates the outer wall part 27 in the disc axial direction.

A recessed part 53 is formed at a portion of the inner wall part 23 on the disc rotation direction inward side. The recessed part 53 is recessed from the inner surface portion 38 of the inner wall part 23 on the disc rotation direction inward side toward the disc rotation direction outward side. The recessed part 53 penetrates the inner wall part 23 in the disc axial direction.

A recessed part (not illustrated) is also formed at a portion of the inner wall part 22 on the disc rotation direction inward side. This recessed part is recessed from the inner surface portion 36 of the inner wall part 22 on the disc rotation direction inward side toward the disc rotation direction outward side. This recessed part penetrates the inner wall part 22 in the disc axial direction.

These recessed parts 51 to 53 and the recessed part (not illustrated) of the inner wall part 22 have the same shape except that their directions are opposite between the disc rotation direction first side and the disc rotation direction second side.

The recessed part 51 of the outer wall part 26 and the recessed part (not illustrated) of the inner wall part 22, which are on the same disc rotation direction first side, coincide with each other in position in the disc radial direction and in the disc rotation direction. The recessed part 51 of the outer wall part 26 and the recessed part (not illustrated) of the inner wall part 22 are separated from each other in the disc axial direction.

The recessed part 52 of the outer wall part 27 and the recessed part 53 of the inner wall part 23, which are on the same disc rotation direction second side, coincide with each other in position in the disc radial direction and in the disc rotation direction. The recessed part 52 of the outer wall part 27 and the recessed part 53 of the inner wall part 23 are separated from each other in the disc axial direction.

The recessed parts 51 to 53 and the recessed part (not illustrated) of the inner wall part 22 have the same shape except that their directions are opposite between the disc rotation direction first side and the disc rotation direction second side. Therefore, of these, the recessed part 52 of the outer wall part 27 illustrated in FIG. 2 will be described here as an example. The recessed part 52 has an outer wall surface portion 55, an inner wall surface portion 56, and a back surface portion 57.

The outer wall surface portion 55 is at an end portion on the disc radially outer side of the recessed part 52 and faces the disc radially inner side. The outer wall surface portion 55 has a planar shape. The outer wall surface portion 55 extends perpendicular to the radial reference line.

The inner wall surface portion 56 is at an end portion on the disc radially inner side of the recessed part 52 and faces the disc radially outer side. The inner wall surface portion 56 has a planar shape. The inner wall surface portion 56 extends perpendicular to the radial reference line.

The back surface portion 57 is at an end portion on the disc rotation direction outward side of the recessed part 52 and faces the disc rotation direction inward side.

The back surface portion 57 connects an end edge portion of the outer wall surface portion 55 on the disc rotation direction outward side and an end edge portion of the inner wall surface portion 56 on the disc rotation direction outward side. The back surface portion 57 extends parallel to the radial reference line and parallel to the disc axis.

The outer wall surface portions 55 in the recessed parts 51 to 53 and the recessed part (not illustrated) of the inner wall part 22 are disposed on the same plane. The inner wall surface portions 56 in the recessed parts 51 to 53 and the recessed part (not illustrated) of the inner wall part 22 are disposed on the same plane. The back surface portions 57 of the recessed part 51 and the recessed part (not illustrated) of the inner wall part 22, both of which are on the disc rotation direction first side, are disposed on the same plane. The back surface portion 57 of the recessed part 52 on the disc rotation direction second side is disposed on the same plane as the back surface portion 57 of the recessed part 53 of the inner wall part 23 on the disc rotation direction second side.

The outer friction pad 8 of the pair of friction pads 8 and 9 is supported by the recessed part 51 of the outer wall part 26 and the recessed part 52 of the outer wall part 27. The inner friction pad 9 of the pair of friction pads 8 and 9 illustrated in FIG. 1 is supported by the recessed part 53 of the inner wall part 23 and the recessed part (not illustrated) of the inner wall part 22.

The pair of friction pads 8 and 9 are common parts having the same shape.

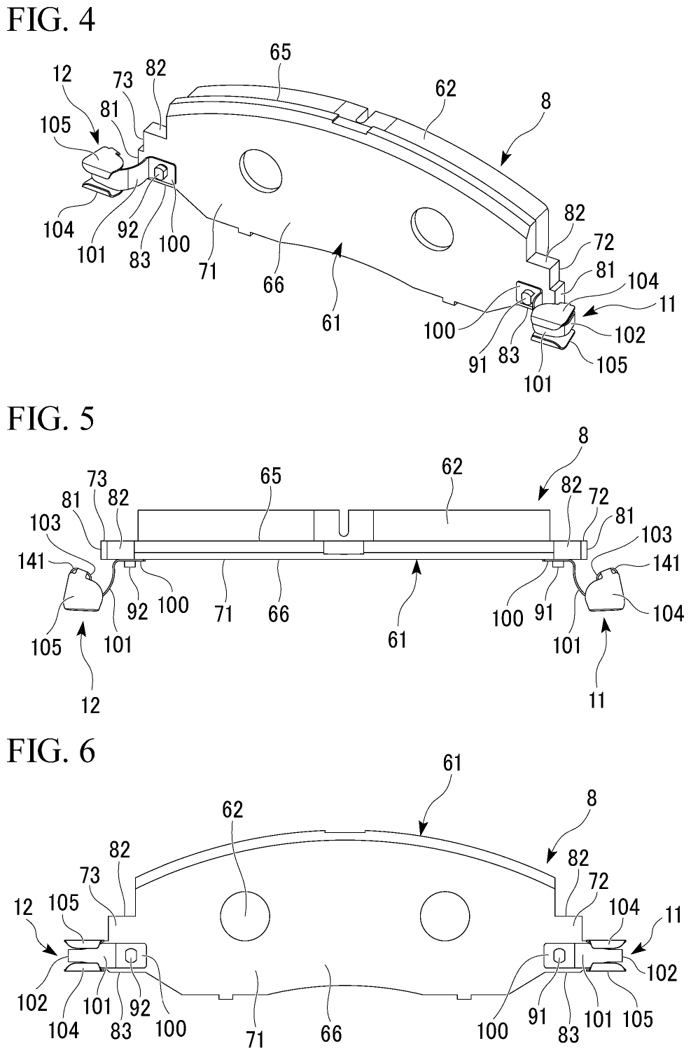

Therefore, here, description will be made by taking the outer friction pad 8 illustrated in FIGS. 2 to 6 as an example. As illustrated in FIG. 4, the outer friction pad 8 includes a back plate 61 and a lining 62. The back plate 61 is formed of a metal. The lining 62 is a friction material that generates frictional resistance. As illustrated in FIG. 5, the lining 62 is attached to an attachment surface 65 on one side of the back plate 61 in a plate thickness direction. A pressing surface 66 of the back plate 61 on a side opposite to the attachment surface 65 in the plate thickness direction extends parallel to the attachment surface 65. The attachment surface 65 and the pressing surface 66 face in opposite directions.

As illustrated in FIG. 4, the back plate 61 has a mirror-symmetrical shape. As illustrated in FIGS. 4 to 6, the back plate 61 includes a main plate part 71 to which the lining 62 is attached, and lug parts 72 and 73 protruding outward in a length direction of the main plate part 71 from both end portions of the main plate part 71 in the length direction. The pair of lug parts 72 and 73 also have a mirror-symmetrical shape. Therefore, one lug part 72 will be described here. The lug part 72 has a substantially rectangular shape. The lug part 72 has a distal end surface portion 81, an outward surface portion 82, and an inward surface portion 83. All of the distal end surface portion 81, the outward surface portion 82, and the inward surface portion 83 are planar and extend in the thickness direction of the back plate 61. The outward surface portion 82 and the inward surface portion 83 are parallel to each other and perpendicular to the distal end surface portion 81.

The distal end surface portions 81 of the pair of lug parts 72 and 73 are parallel to each other and face in directions opposite to each other. As illustrated in FIG. 6, the outward surface portion 82 of the pair of lug parts 72 and 73 are disposed on the same plane. The inward surface portions 83 of the pair of lug parts 72 and 73 are disposed on the same plane.

As illustrated in FIG. 4, a protruding part 91 protruding to a side opposite to the lining 62 from the pressing surface 66 is formed on the pressing surface 66 of the back plate 61 at a position of the lug part 72. A protruding part 92 protruding to a side opposite to the lining 62 from the pressing surface 66 is formed on the pressing surface 66 of the back plate 61 at a position of the lug part 73.

As illustrated in FIG. 2, the outer friction pad 8 is supported by the recessed part 51 of the outer wall part 26 and the recessed part 52 of the outer wall part 27. At that time, the outer friction pad 8 is in a state in which the back plate 61 is disposed on the outer side with respect to the lining 62. Also, at that time, the outer friction pad 8 is inserted into the recessed part 51 of the outer wall part 26 with the lug part 72 disposed at an end portion of the friction pad 8 on the disc rotation direction first side. Also, at that time, the outer friction pad 8 is inserted into the recessed part 52 of the outer wall part 27 with the lug part 73 disposed at an end portion of the friction pad 8 on the disc rotation direction second side. In other words, the pair of lugs parts 72 and 73 of the outer friction pad 8 are disposed in a nested state in the recessed parts 51 and 52 of the pair of outer wall parts 26 and 27.

Then, in the lug part 72, the distal end surface portion 81 illustrated in FIGS. 4 and 5 faces the back surface portion 57 of the recessed part 51 illustrated in FIG. 2, the outward surface portion 82 illustrated in 4 and 5 faces the outer wall surface portion 55 of the recessed part 51 illustrated in FIG. 2, and the inward surface portion 83 illustrated in FIGS. 4 and 6 faces the inner wall surface portions 56 of the recessed part 51. Similarly, in the lug part 73, the distal end surface portion 81 faces the back surface portion 57 of the recessed part 52, the outward surface portion 82 faces the outer wall surface portion 55 of the recessed part 52, and the inward surface portion 83 faces the inner wall surface portions 56 of the recessed part 52.

The outer friction pad 8 supported by the carrier 5 in this way is in a state of extending in the disc rotation direction. In this state, the outer friction pad 8 is positioned on the outer side of the disc 2 to be movable with respect to the carrier 5 in the disc axial direction. Also, in this state, the outer friction pad 8 causes the lining 62 to face the disc 2.

When the inward surface portion 83 illustrated in FIG. 6 of the lug part 72 of the outer friction pad 8 comes into contact with the inner wall surface portion 56 illustrated in FIG. 2, the recessed part 51 of the outer wall part 26 restricts further movement of the lug part 72 inward in the disc radial direction. When the outward surface portion 82 illustrated in FIGS. 4 to 6 of the lug part 72 of the outer friction pad 8 comes into contact with the outer wall surface portion 55 illustrated in FIG. 2, the recessed part 51 of the outer wall part 26 restricts further movement of the lug part 72 outward in the disc radial direction. When the distal end surface portion 81 illustrated in FIGS. 4 and 5 of the lug part 72 of the outer friction pad 8 comes into contact with the back surface portion 57 illustrated in FIG. 2, the recessed part 51 of the outer wall part 26 restricts further movement of the lug part 72 to the disc rotation direction first side.

When the inward surface portion 83 of the lug part 73 of the outer friction pad 8 comes into contact with the inner wall surface portion 56, the recessed part 52 of the outer wall part 27 restricts further movement of the lug part 73 inward in the disc radial direction. When the outward surface portion 82 of the lug part 73 of the outer friction pad 8 comes into contact with the outer wall surface portion 55, the recessed part 52 of the outer wall part 27 restricts further movement of the lug part 73 outward in the disc radial direction. When the distal end surface portion 81 of the lug part 73 of the outer friction pad 8 comes into contact with the back surface portion 57, the recessed part 52 of the outer wall part 27 restricts further movement of the lug part 73 of the outer friction pad 8 to the disc rotation direction second side.

As described above, the recessed parts 51 and 52 of the pair of outer wall parts 26 and 27 of the carrier 5 support the pair of lug parts 72 and 73 of the outer friction pad 8 to be movable in the disc axial direction while restricting movement thereof in the disc radial direction and the disc rotation direction. The back plate 61 of the outer friction pad 8 has a plate thickness direction thereof aligned in the disc axial direction while being supported by the carrier 5 as described above.

The inner friction pad 9 illustrated in FIG. 1 is supported by the recessed part 53 of the inner wall part 23 and the recessed part (not illustrated) of the inner wall part 22 illustrated in FIG. 2 similarly to the support of the outer friction pad 8 due to the recessed parts 51 and 52 of the outer wall parts 26 and 27. That is, the lug part (not illustrated) of the inner friction pad 9 on the disc rotation direction first side is inserted into the recessed part (not illustrated) of the inner wall part 22. At the same time, the lug part (not illustrated) of the inner friction pad 9 on the disc rotation direction second side is inserted into the recessed part 53 of the inner wall part 23. Therefore, the pair of lug parts (not illustrated) of the inner friction pad 9 are disposed in a nested state in the recessed part (not illustrated) of the inner wall part 22 and the recessed part 53 of the inner wall part 23. At that time, the inner friction pad 9 is in a state in which the back plate (not illustrated) is disposed on the inner side with respect to the lining 62.

The inner friction pad 9 supported by the carrier 5 in this way is in a state of extending in the disc rotation direction. Also, in this state, the inner friction pad 9 is positioned on the inner side of the disc 2 to be movable with respect to the carrier 5 in the disc axial direction.

In the carrier 5, the pair of the recessed part (not illustrated) of the inner wall part 22 and the recessed part 53 of the inner wall part 23 support the pair of lug parts (not illustrated) of the inner friction pad 9 to be movable in the disc axial direction while restricting movement thereof in the disc radial direction and the disc rotation direction. The back plate (not illustrated) of the inner friction pad 9 has a plate thickness direction thereof aligned in the disc axial direction while being supported by the carrier 5 as described above.

As described above, the pair of friction pads 8 and 9 are both supported by the carrier 5. At that time, the pair of friction pads 8 and 9 each face the disc 2 at the lining 62. That is, the outer friction pad 8 supported by the pair of outer wall parts 26 and 27 faces a lateral surface of the disc 2 facing the outer side at the lining 62. Also, the inner friction pad 9 supported by the pair of inner wall parts 22 and 23 faces a lateral surface of the disc 2 facing the inner side at the lining 62. Then, at the time of braking, the pair of friction pads 8 and 9 come into contact with the lateral surfaces of the disc 2 that they face at the linings 62.

As illustrated in FIGS. 2 to 6, the return spring 11 is attached to the lug part 72 on the disc rotation direction first side of the back plate 61 of the outer friction pad 8. The return spring 12 is attached to the lug part 73 on the disc rotation direction second side of the back plate 61 of the outer friction pad 8. The return springs 11 and 12 are both provided on a side of the outer friction pad 8 opposite to the lining 62 in the plate thickness direction of the back plate 61. The return springs 11 and 12 are both attached to the back plate 61 in a state in which they are in surface contact with the pressing surface 66 of the back plate 61 of the outer friction pad 8.

The return spring 13 illustrated in FIG. 1 is attached to the lug part on the disc rotation direction first side of the back plate (not illustrated) of the inner friction pad 9. The return spring 14 is attached to the lug part on the disc rotation direction second side of the back plate (not illustrated) of the inner friction pad 9. The return springs 13 and 14 are both attached to the back plate (not illustrated) in a state in which they are in surface contact with the pressing surface of the back plate on a side opposite to the lining 62 in the inner friction pad 9.

The return springs 11 to 14 are common parts having the same shape.

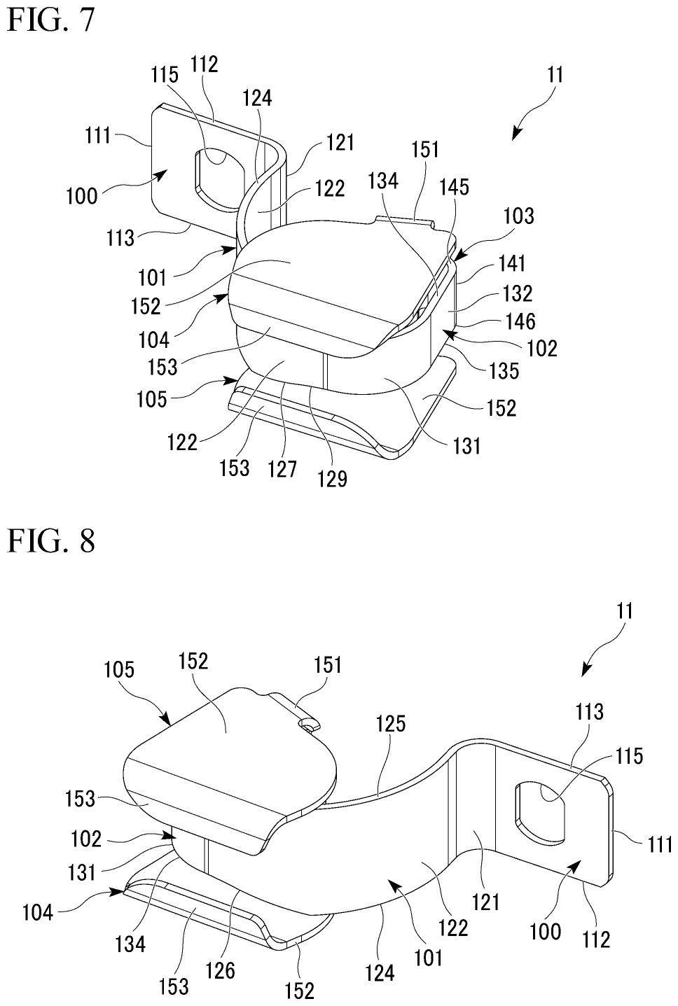

Therefore, here, description will be made by taking the return spring 11 attached to the disc rotation direction first side of the outer friction pad 8 as an example. As illustrated in FIGS. 7 to 9, the return spring 11 has a mirror-symmetrical shape. The return spring 11 includes a fixing part 100 illustrated in FIGS. 7 to 10, a first extension part 101, a second extension part 102, a contact part 103 illustrated in FIG. 10, and a pair of cover parts 104 and 105 illustrated in FIGS. 7 to 9. The return spring 11 is formed of a plate material having spring properties, specifically, a steel plate. The return spring 11 is integrally formed by punching and bending one flat plate-shaped steel plate having a constant plate thickness using press working. Therefore, in the return spring 11, the fixing part 100, the first extension part 101, the second extension part 102, the contact part 103, and the pair of cover parts 104 and 105 are seamlessly and integrally formed. In other words, the return spring 11 is seamlessly and integrally formed in its entirety.

The fixing part 100 has a plate shape, and has a flat plate shape with a constant plate thickness. The fixing part 100 has a quadrangular shape when viewed from a plate thickness direction. The fixing part 100 includes an edge portion 111, an edge portion 112, and an edge portion 113 as illustrated in FIGS. 7 to 9. All the edge portions 111 to 113 are surfaces extending in the plate thickness direction of the fixing part 100.

The edge portion 111 extends in one direction. The edge portion 111 has a flat surface at an intermediate portion in an extension direction, and has a curved surface whose center of curvature is inside the fixing part 100 at both end sides in the extension direction.

The edge portion 112 extends linearly in one direction. The edge portion 112 has a planar shape. The edge portion 112 extends perpendicular to the flat surface portion of the edge portion 111 from one end portion in a direction in which the edge portion 111 extends.

The edge portion 113 extends linearly in one direction. The edge portion 113 has a planar shape. The edge portion 113 extends perpendicular to the flat surface portion of the edge portion 111 from the other end portion on a side opposite to the edge portion 112 in a direction in which the edge portion 111 extends. The edge portion 112 and the edge portion 113 face each other in opposite directions and extend parallel to each other.

The fixing part 100 includes a fixing hole 115 formed to penetrate the fixing part 100 in the plate thickness direction. The fixing hole 115 is an elongated hole in which a width in a direction in which the edge portion 111 extends is larger than a width in a direction in which the edge portions 112 and 113 extend.

The first extension part 101 has a plate shape and extends from the fixing part 100 to one side in the plate thickness direction of the fixing part 100. The first extension part 101 has a substantially constant plate thickness and is curved in the plate thickness direction. The first extension part 101 includes a protruding plate part 121 and an extension plate part 122.

As illustrated in FIGS. 7 and 8, the protruding plate part 121 has a curved plate shape that is curved in an arcuate shape in a plate thickness direction thereof. The protruding plate part 121 protrudes from an end portion of the fixing part 100 on a side opposite to the edge portion 111 to one side in the plate thickness direction of the fixing part 100. The protruding plate part 121 is curved such that a center of curvature thereof is positioned on the edge portion 111 side in a direction in which the edge portions 112 and 113 extend with respect to the protruding plate part 121.

The extension plate part 122 extends in a direction opposite to the fixing part 100 in the plate thickness direction of the fixing part 100 from an end portion of the protruding plate part 121 on a side opposite to the fixing part 100. The extension plate part 122 is curved in an arcuate shape so that it becomes further away from the edge portion 111 in a direction in which the edge portions 112 and 113 extend with distance extending from the protruding plate part 121. The extension plate part 122 is curved such that a center of curvature thereof is positioned on a side opposite to the edge portion 111 in a direction in which the edge portions 112 and 113 extend with respect to the extension plate part 122.

In the first extension part 101, the protruding plate part 121 has an arcuate shape, and the extension plate part 122 also has an arcuate shape. In other words, the first extension part 101 is curved in its entirety.

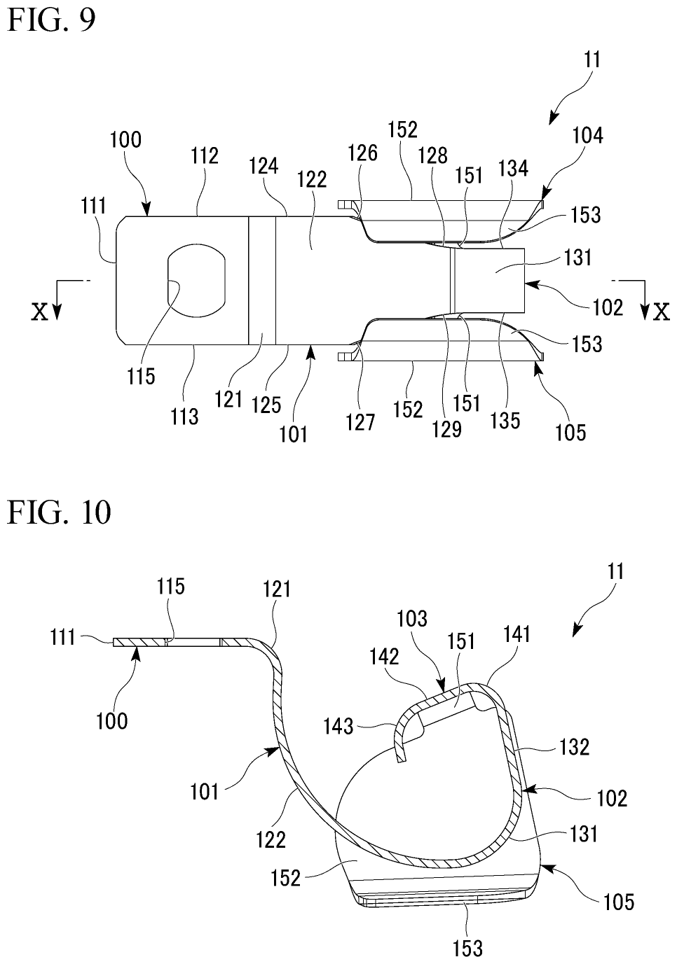

As illustrated in FIG. 7, FIG. 8, or FIG. 9, the first extension part 101 has an edge portion 124, an edge portion 125, an edge portion 126, an edge portion 127, an edge portion 128, and an edge portion 129. All the edge portions 124 to 129 are surfaces extending in a plate thickness direction of the first extension part 101.

As illustrated in FIG. 7, the edge portion 124 is formed at an end portion on the protruding plate part 121 side in a direction in which the extension plate part 122 extends and on the protruding plate part 121. The edge portion 124 extends from an end edge portion of the edge portion 112 on a side opposite to the edge portion 111. The edge portion 124 is planar and disposed on the same plane as the edge portion 112.

As illustrated in FIG. 8, the edge portion 125 is formed at an end portion on the protruding plate part 121 side in a direction in which the extension plate part 122 extends and on the protruding plate part 121. The edge portion 125 extends from an end edge portion of the edge portion 113 on a side opposite to the edge portion 111. The edge portion 125 is planar and disposed on the same plane as the edge portion 113.

Therefore, edge portion 125 faces in a direction opposite to the edge portion 124 and is parallel to the edge portion 124.

As illustrated in FIG. 9, the edge portion 126 is formed at an intermediate portion in a direction in which the extension plate part 122 extends. The edge portion 126 extends from an end edge portion of the edge portion 124 on a side opposite to the edge portion 112. The edge portion 126 is planar and inclined with respect to the edge portion 124.

The edge portion 127 is formed at an intermediate portion in a direction in which the extension plate part 122 extends. The edge portion 127 extends from an end edge portion of the edge portion 125 on a side opposite to the edge portion 113. The edge portion 127 is planar and inclined with respect to the edge portion 125.

The edge portions 126 and 127 face each other in opposite directions, and are inclined with respect to the edge portions 124 and 125 so that they approach each other with distance away from the edge portions 124 and 125.

The edge portion 128 is formed at an end portion on a side opposite to the protruding plate part 121 in a direction in which the extension plate part 122 extends. The edge portion 128 extends from an end edge portion of the edge portion 126 on a side opposite to the edge portion 124. The edge portion 128 has a curved surface shape.

The edge portion 129 is formed at an end portion on a side opposite to the protruding plate part 121 in a direction in which the extension plate part 122 extends. The edge portion 129 extends from an end edge portion of the edge portion 127 on a side opposite to the edge portion 125. The edge portion 129 has a curved surface shape. The edge portion 129 faces in a direction opposite to the edge portion 128.

The second extension part 102 has a plate shape, and extends from an end portion of the first extension part 101 on a side opposite to the fixing part 100 to just short of the fixing part 100 in the plate thickness direction of the fixing part 100 as illustrated in FIG. 10. The second extension part 102 has a substantially constant plate thickness and is partially curved in the plate thickness direction. The second extension part 102 includes a connection plate part 131 and an intermediate extension plate part 132.

The connection plate part 131 has a curved plate shape that is curved in an arcuate shape in a plate thickness direction thereof. The connection plate part 131 extends from an end portion of the extension plate part 122 on a side opposite to the protruding plate part 121 in a direction away from the edge portion 111 in a direction in which the edge portions 112 and 113 extend, and in a direction toward the fixing part 100 in the plate thickness direction of the fixing part 100 as illustrated in FIG. 7. The connection plate part 131 is curved such that a center of curvature thereof is positioned on the edge portion 111 side in a direction in which the edge portions 112 and 113 extend with respect to the connection plate part 131.

The intermediate extension plate part 132 has a flat plate shape, and extends to approach the fixing part 100 in the plate thickness direction of the fixing part 100 from an end portion of the connection plate part 131 on a side opposite to the extension plate part 122. The intermediate extension plate part 132 approaches the edge portion 111 in a direction in which the edge portions 112 and 113 extend toward an extension distal end side.

The second extension part 102 has an edge portion 134 and an edge portion 135.

The edge portions 134 and 135 are formed on the connection plate part 131 and the intermediate extension plate part 132. Both the edge portions 134 and 135 are surfaces that extend in a plate thickness direction of the second extension part 102.

As illustrated in FIG. 9, the edge portion 134 extends from an end edge portion of the edge portion 128 on a side opposite to the edge portion 126. The edge portion 134 is planar and extends parallel to the edge portion 124. The edge portion 128 is slightly curved to gently connect the edge portion 126 and the edge portion 134.

The edge portion 135 extends from an end edge portion of the edge portion 129 on a side opposite to the edge portion 127. The edge portion 135 is planar and extends parallel to the edge portion 125. The edge portion 129 is slightly curved to gently connect the edge portion 127 and the edge portion 135. The edge portion 135 faces in a direction opposite to the edge portion 134 and is parallel to the edge portion 134. A distance between the edge portions 134 and 135 is smaller than a distance between the edge portions 124 and 125.

As illustrated in FIG. 10, the contact part 103 has a plate shape, and extends in a direction of the first extension part 101 from an end portion of the intermediate extension plate part 132 of the second extension part 102 on a side opposite to the connection plate part 131. The contact part 103 is disposed on the same side as the first extension part 101 and the second extension part 102 with respect to the fixing part 100 in the plate thickness direction of the fixing part 100. The contact part 103 has a substantially constant plate thickness and is partially curved in the plate thickness direction. The contact part 103 includes a contact plate part 141, an intermediate plate part 142, and an inwardly extending plate part 143.

The contact plate part 141 has a curved plate shape that is curved in a plate thickness direction thereof. As illustrated in FIG. 7, the contact plate part 141 extends to the fixing part 100 side in a direction in which the edge portions 112 and 113 extend from an end portion of the intermediate extension plate part 132 on a side opposite to the connection plate part 131. As illustrated in FIG. 10, the contact plate part 141 is curved such that a center of curvature thereof is positioned on a side opposite to the fixing part 100 in the plate thickness direction of the fixing part 100 with respect to the contact plate part 141.

The intermediate plate part 142 has a flat plate shape, and extends from an end portion of the contact plate part 141 on a side opposite to the intermediate extension plate part 132. The intermediate plate part 142 extends from the contact plate part 141 to the edge portion 111 side as illustrated in FIG. 10 in a direction in which the edge portions 112 and 113 illustrated in FIG. 7 extend. The intermediate plate part 142 becomes further away from the fixing part 100 in the plate thickness direction of the fixing part 100 toward an extension distal end side. The intermediate plate part 142 forms an acute angle of less than 90 degrees with the intermediate extension plate part 132.

The inwardly extending plate part 143 has a curved plate shape that is curved in a plate thickness direction thereof. The inwardly extending plate part 143 extends from an end portion of the intermediate plate part 142 on a side opposite to the contact plate part 141 to a side opposite to the fixing part 100 in the plate thickness direction of the fixing part 100. The inwardly extending plate part 143 is curved such that a center of curvature thereof is positioned on a side opposite to the edge portion 111 in a direction in which the edge portions 112 and 113 illustrated in FIG. 7 extend with respect to the inwardly extending plate part 143.

The contact part 103 has an edge portion 145 and an edge portion 146 illustrated in FIG. 7. The edge portions 145 and 146 are formed on the contact plate part 141 and the inwardly extending plate part 143, an end portion of the intermediate plate part 142 on the contact plate part 141 side, and an end portion of the intermediate plate part 142 on the inwardly extending plate part 143 side illustrated in FIG. 10. Both the edge portions 145 and 146 illustrated in FIG. 7 are surfaces that extend in a plate thickness direction of the contact part 103.

The edge portion 145 extends from an end edge portion of the edge portion 134 on a side opposite to the edge portion 128 illustrated in FIG. 8. The edge portion 145 illustrated in FIG. 7 is planar and disposed on the same plane as the edge portion 134.

The edge portion 146 extends from an end edge portion of the edge portion 135 on a side opposite to the edge portion 129. The edge portion 146 is planar and disposed on the same plane as the edge portion 135. Therefore, the edge portion 146 faces in a direction opposite to the edge portion 145 and is parallel to the edge portion 145.

In each of the fixing part 100, the first extension part 101, the second extension part 102, and the contact part 103, a line in the plate thickness direction passes through one plane. The edge portions 112, 113, 124, 125, 134, 135, 145, and 146 are parallel to the planes, respectively.

The cover parts 104 and 105 illustrated in FIGS. 7 to 9 are provided in the return spring 11 to extend from at least one of the first extension part 101, the second extension part 102, and the contact part 103 illustrated in FIG. 10. Specifically, the cover parts 104 and 105 illustrated in FIGS. 7 to 9 extend from the intermediate plate part 142 of the contact part 103 illustrated in FIG. 10.

In the pair of cover parts 104 and 105 illustrated in FIGS. 7 to 9, the cover part 104 extends from the edge portion 145 of the contact part 103 illustrated in FIG. 7, and the cover part 105 extends from the edge portion 146 of the contact part 103. The pair of cover parts 104 and 105 have a mirror-symmetrical shape. Both the cover parts 104 and 105 have a substantially constant plate thickness and are partially curved in the plate thickness direction. The cover parts 104 and 105 each include a base end plate part 151, a cover plate part 152, and a distal end plate part 153 illustrated in FIG. 9.

The base end plate part 151 of the cover part 104 protrudes from the edge portion 145 of the contact part 103 illustrated in FIG. 7. The base end plate part 151 of the cover part 105 illustrated in FIG. 9 protrudes from the edge portion 146 of the contact part 103 illustrated in FIG. 7. As the base end plate part 151 of the cover part 105 illustrated in FIG. 10, the base end plate parts 151 of the cover parts 104 and 105 illustrated in FIG. 9 are each provided to be positioned at the intermediate plate part 142 of the contact part 103 and each protrude from the intermediate plate part 142.

The base end plate part 151 of the cover part 104 illustrated in FIG. 9 curves to the second extension part 102 side in a plate thickness direction of the intermediate plate part 142 illustrated in FIG. 10 while protruding in a direction perpendicular to the edge portion 145, which is a surface, illustrated in FIG. 7. The base end plate part 151 of the cover part 105 curves to the second extension part 102 side in the plate thickness direction of the intermediate plate part 142 illustrated in FIG. 10 while protruding in a direction perpendicular to the edge portion 146, which is a surface, illustrated in FIG. 7.

As illustrated in FIGS. 7 and 8, the cover plate parts 152 of the cover parts 104 and 105 both have a flat plate shape. The cover plate part 152 of the cover part 104 illustrated in FIG. 7 extends from an end portion of the base end plate part 151 of the cover part 104 on a side opposite to the contact part 103 in a direction away from the intermediate plate part 142 in the plate thickness direction of the intermediate plate part 142 illustrated in FIG. 10. The cover plate part 152 of the cover part 105 extends from an end portion of the base end plate part 151 of the cover part 105 on a side opposite to the contact part 103 in a direction away from the intermediate plate part 142 in the plate thickness direction of the intermediate plate part 142. The cover plate parts 152 of the cover parts 104 and 105 illustrated in FIG. 7 both extend parallel to the edge portions 134, 135, 145, and 146 which are surfaces. Therefore, the cover plate parts 152 of the cover parts 104 and 105 extend in parallel.

As the cover plate part 152 of the cover part 105 illustrated in FIG. 10, the cover plate parts 152 of the cover parts 104 and 105 both extend to a side opposite to the fixing part 100 with respect to the first extension part 101 and the second extension part 102 in the plate thickness direction of the fixing part 100. As the cover plate part 152 of the cover part 105 illustrated in FIG. 10, both the cover plate parts 152 of the cover parts 104 and 105 overlap the entire second extension part 102, a portion of the extension plate part 122 on the connection plate part 131 side, and a distal end portion of the inwardly extending plate part 143 of the contact part 103 on a side opposite to the intermediate plate part 142 in position in a direction in which the edge portions 134 and 135, which are surfaces, extend.

The cover plate part 152 of the cover part 104 illustrated in FIGS. 7 to 9 covers at least a part of the edge portions 124, 126, 128, 134, and 145 illustrated in FIG. 7 or 9. Specifically, the cover plate part 152 of the cover part 104 faces and covers a part of the edge portion 124 on the edge portion 126 side, the entire edge portion 126, the entire edge portion 128, and the entire edge portion 134 illustrated in FIG. 9, and a distal end portion of the edge portion 145 on a side opposite to the edge portion 134 illustrated in FIG. 7 in a direction perpendicular to the edge portion 134.

The cover plate part 152 of the cover part 105 illustrated in FIGS. 7 to 10 covers at least a part of the edge portions 125, 127, 129, 135, and 146 illustrated in FIG. 7 or FIG. 9. Specifically, the cover plate part 152 of the cover part 105 faces and covers a part of the edge portion 125 on the edge portion 127 side, the entire edge portion 127, the entire edge portion 129, the entire edge portion 135, and a distal end portion of the edge portion 146 on a side opposite to the edge portion 135 in a direction perpendicular to the edge portion 135.

As illustrated in FIGS. 7 and 8, the distal end plate part 153 of the cover part 104 extends from an end edge portion of the cover plate part 152 of the cover part 104 on a side opposite to the base end plate part 151. The distal end plate part 153 of the cover part 104 protrudes from the cover plate part 152 of the cover part 104 while being curved to approach the cover part 105 in a plate thickness direction of the cover plate part 152.

The distal end plate part 153 of the cover part 105 extends from an end edge portion of the cover plate part 152 of the cover part 105 on a side opposite to the base end plate part 151. The distal end plate part 153 of the cover part 105 protrudes from the cover plate part 152 of the cover part 105 while being curved to approach the cover part 104 in the plate thickness direction of the cover plate part 152.

As illustrated in FIGS. 4 to 6, the return spring 11 is attached to the lug part 72 of the outer friction pad 8. At that time, the protruding part 91 provided on the lug part 72 illustrated in FIGS. 4 to 6 is fitted into the fixing hole 115 illustrated in FIGS. 7 to 10, and the return spring 11 is brought into contact with the pressing surface 66 at the fixing part 100. Moreover, the return spring 11 is disposed such that the first extension part 101 and the second extension part 102 illustrated in FIG. 4, the contact part 103 illustrated in FIG. 5, and the cover parts 104 and 105 illustrated in FIG. 4 are positioned on a side opposite to the main plate part 71 with respect to the fixing part 100.

In this state, the fixing part 100 of the return spring 11 is fixed to the lug part 72 by swaging and crushing a portion of the protruding part 91 that protrudes from the fixing part 100. Here, the protruding part 91 has the same shape as the fixing hole 115, which is an elongated hole, illustrated in FIGS. 7 to 9 and performs rotation stop for the return spring 11 with respect to the friction pad 8.

In this way, the fixing part 100 of the return spring 11 is fixed to the friction pad 8. In this state, in the return spring 11, the first extension part 101 and the second extension part 102 illustrated in FIG. 4, the contact part 103 illustrated in FIG. 5, and the cover parts 104 and 105 illustrated in FIG. 4 protrude to a side opposite to the main plate part 71 with respect to the lug part 72. In this state, in the return spring 11, among the second extension part 102, the contact part 103, and the cover parts 104 and 105, the contact plate part 141 of the contact part 103 illustrated in FIG. 5 is positioned closest to the back plate 61 side in the plate thickness direction of the back plate 61 of the friction pad 8.

As illustrated in FIGS. 4 to 6, the return spring 12 is fixed to the lug part 73 of the outer friction pad 8 not to rotate similarly to the return spring 11. At that time, the return spring 12 comes into contact with the pressing surface 66 at the fixing part 100 and is disposed such that the first extension part 101 and the second extension part 102 illustrated in FIG. 6, the contact part 103 illustrated in FIG. 5, and the cover parts 104 and 105 illustrated in FIG. 4 are positioned on a side opposite to the main plate part 71 with respect to the fixing part 100.

The fixing part 100 of the return spring 12 is fixed to the friction pad 8. In this state, in the return spring 12, the first extension part 101 and the second extension part 102 illustrated in FIG. 6, the contact part 103 illustrated in FIG. 5, and the cover parts 104 and 105 illustrated in FIG. 4 protrude to a side opposite to the main plate part 71 with respect to the lug part 73. In this state, in the return spring 12, among the second extension part 102, the contact part 103, and the cover parts 104 and 105, the contact plate part 141 of the contact part 103 illustrated in FIG. 5 is positioned closest to the back plate 61 side in the plate thickness direction of the back plate 61 of the friction pad 8.

As illustrated in FIG. 2, the outer friction pad 8 is supported by the recessed parts 51 and 52 of the pair of outer wall parts 26 and 27 of the carrier 5 as described above with the return springs 11 and 12 attached. Then, the pair of return springs 11 and 12 are both disposed on the outer side of the outer friction pad 8. Also, one return spring 11 of the return springs 11 and 12 is disposed on the disc rotation direction first side. Also, the other return spring 12 of the return springs 11 and 12 is disposed on the disc rotation direction second side.

In the return spring 11, the edge portions 124 to 129, 134, 135, 145, and 146 illustrated in FIG. 7 or 9 face in the disc radial direction. The return spring 11 is configured such that the cover part 104 covers a part of the edge portion 124, the entire edge portion 126, the entire edge portion 128, the entire edge portion 134, and the distal end portion of the edge portion 145 from the disc radially outer side. Also, the return spring 11 is configured such that the cover part 105 covers a part of the edge portion 125, the entire edge portion 127, the entire edge portion 129, the entire edge portion 135, and the distal end portion of the edge portion 146 from the disc radially inner side.

As illustrated in FIG. 2, the first extension part 101 of the return spring 11 extends from the fixing part 100 in a direction away from the friction pad 8 in a plate thickness direction of the friction pad 8. At that time, the first extension part 101 of the return spring 11 extends in a direction away from the fixing part 100 to the disc rotation direction first side. The second extension part 102 of the return spring 11 extends to the inner side in the plate thickness direction of the friction pad 8 from the end portion of the first extension part 101 on a side opposite to the fixing part 100. That is, the second extension part 102 of the return spring 11 extends from the first extension part 101 in a direction in which the friction pad 8 is pressed by the caliper 6 (to be described later) illustrated in FIG. 1.

As illustrated in FIG. 2, in the return spring 11, the first extension part 101, the second extension part 102, the contact part 103, and the cover parts 104 and 105, all of which are on the disc rotation direction first side with respect to the fixing part 100, overlap the outer wall part 26 in position in the disc rotation direction and the disc radial direction. Also, at least a part of the first extension part 101, the second extension part 102, the contact part 103, and the cover parts 104 and 105 of the return spring 11 overlap the outer protruding part 28 in position in the disc rotation direction, the disc radial direction, and the disc axial direction. At least a part of the outer protruding part 28 is offset to the disc rotation direction outward side with respect to the return spring 11, and at least a part thereof is offset to the disc radially inner side with respect to the return spring 11. The contact part 103 of the return spring 11 extends from the second extension part 102 and comes into contact with the surface portion 45 of the outer wall part 26 of the carrier 5 at the contact plate part 141 as illustrated in FIG. 3. At that time, the contact part 103 of the return spring 11 extends to the disc rotation direction second side from the second extension part 102 thereof illustrated in FIG. 2.

The first extension part 101 of the return spring 12 extends from the fixing part 100 in a direction away from the friction pad 8 in the plate thickness direction of the friction pad 8. At that time, the first extension part 101 of the return spring 12 extends in a direction away from the fixing part 100 to the disc rotation direction second side. In the return spring 12, the second extension part 102 thereof illustrated in FIG. 6 extends to the inner side in the plate thickness direction of the friction pad 8 from the end portion of the first extension part 101 on a side opposite to the fixing part 100 illustrated in FIG. 2. That is, in the return spring 12, the second extension part 102 thereof illustrated in FIG. 6 extends from the first extension part 101 in a direction in which the friction pad 8 is pressed by the caliper 6 (to be described later).

In the return spring 12, the first extension part 101, the second extension part 102, the contact part 103, and the cover parts 104 and 105 illustrated in FIG. 2, FIG. 3, or FIG. 6, all of which are positioned on the disc rotation direction second side with respect to the fixing part 100, overlap the outer wall part 27 in position in the disc rotation direction and the disc radial direction. Also, at least a part of the first extension part 101, the second extension part 102, the contact part 103, and the cover parts 104 and 105 of the return spring 12 overlap the outer protruding part 29 in position in the disc rotation direction, the disc radial direction, and the disc axial direction. At least a part of the outer protruding part 29 is offset to the disc rotation direction outward side with respect to the return spring 12, and at least a part thereof is offset to the disc radially inner side with respect to the return spring 12. The contact part 103 of the return spring 12 extends from the second extension part 102 and comes into contact with the surface portion 47 of the outer wall part 27 of the carrier 5 at the contact plate part 141 as illustrated in FIG. 3. At that time, the contact part 103 of the return spring 12 extends to the disc rotation direction first side from the second extension part 102 thereof illustrated in FIG. 6.

Similarly to the attachment of the return springs 11 and 12 to the friction pad 8 described above, also on the inner friction pad 9 illustrated in FIG. 1, the return spring 13 is attached on the disc rotation direction first side, and the return spring 14 is attached on the disc rotation direction second side. The return spring 13 is in contact with the surface portion 35, illustrated in FIG. 3, of the inner wall part 22 of the carrier 5. The return spring 14 illustrated in FIG. 1 is in contact with the surface portion 37, illustrated in FIG. 3, of the inner wall part 23 of the carrier 5.

As illustrated in FIG. 1, the caliper 6 has a substantially mirror-symmetrical shape. The caliper 6 includes a caliper body 161, the slide pins 41 and 42 described above, attachment bolts 162 and 163, and a piston (not illustrated).

The caliper body 161 is seamlessly integrally formed by casting. The caliper body 161 includes a cylinder part 171, a bridge part 172, a pressing claw 173, and a pair of pin attachment parts 174 and 175. In the caliper body 161, the slide pin 41 is attached to one pin attachment part 174 of the pair of pin attachment parts 174 and 175 by the attachment bolt 162. In the caliper body 161, the slide pin 42 is attached to the other pin attachment part 175 of the pair of pin attachment parts 174 and 175 by the attachment bolt 163. The caliper body 161 is supported by the carrier 5 via the slide pins 41 and 42. At that time, the slide pin 41 is slidably fitted into a pin insertion hole (not illustrated) in the pin insertion part 24 of the carrier 5, and the slide pin 42 is slidably fitted into a pin insertion hole (not illustrated) in the pin insertion part 25. Thereby, the caliper 6 including the caliper body 161 is provided on the carrier 5 to be movable in the disc axial direction. The pair of boots 7 cover portions of the corresponding slide pins 41 and 42 protruding from the carrier 5.

With the caliper body 161 supported by the carrier 5, the cylinder part 171 is disposed on the inner side of the disc 2 in the disc axial direction.

With the caliper body 161 in this supported state, the bridge part 172 extends to the outer side in the disc axial direction to straddle a circumference of the disc 2 from an end edge portion of the cylinder part 171 on the disc radially outer side.

With the caliper body 161 in this supported state, the pressing claw 173 extends to the disc radially inner side from an end edge portion of the bridge part 172 on a side opposite to the cylinder part 171. The pressing claw 173 is disposed on the outer side with respect to the disc 2 in the disc axial direction.

With the caliper body 161 in this supported state, the pin attachment part 174 extends from the cylinder part 171 to the disc rotation direction first side, and the pin attachment part 175 extends from the cylinder part 171 to the disc rotation direction second side.

In the caliper body 161, a pair of pistons (not illustrated) are housed in the cylinder part 171 to be movable in the disc axial direction. The pair of pistons (not illustrated) have the same shape, and are provided to be aligned in the disc rotation direction with their positions aligned in the disc radial direction. The pair of pistons (not illustrated) are provided to be able to protrude from the cylinder part 171 to the pressing claw 173 side.

The inner friction pad 9 supported by the carrier 5 is disposed between the disc 2 and the pair of pistons (not illustrated) of the caliper 6 also supported by the carrier 5. The outer friction pad 8 supported by the carrier 5 is disposed between the disc 2 and the pressing claw 173 of the caliper 6 also supported by the carrier 5. At that time, the linings 62 of both the friction pads 8 and 9 are directed toward the disc 2 side.

A brake fluid is introduced into the cylinder part 171 of the caliper 6 via a brake pipe (not illustrated). Then, a brake hydraulic pressure acts on the pair of pistons (not illustrated) in the cylinder part 171. As a result, the pair of pistons (not illustrated) move forward to the disc 2 side and press the inner friction pad 9 disposed between these pistons and the disc 2 toward the disc 2. Then, when the pair of lug parts (not illustrated) are both guided by the recessed part 53 and the recessed part (not illustrated) on the inner side, the inner friction pad 9 moves to the disc 2 side, that is, to the outer side, with respect to the carrier 5, and brings the lining 62 thereof into contact with the inner lateral surface of the disc 2.

Due to such a reaction force of the pressing by the pair of pistons (not illustrated), the caliper body 161 slides the slide pins 41 and 42 with respect to the carrier and moves in the disc axial direction. Thereby, the pressing claw 173 of the caliper body 161 presses the outer friction pad 8 disposed between the pressing claw 173 and the disc 2 toward the disc 2. Then, when the pair of lug parts 72 and 73 are guided by the pair of recessed parts 51 and 52 on the outer side, the outer friction pad 8 illustrated in FIG. 2 moves to the disc 2 side, that is, to the inner side, with respect to the carrier 5, and brings the lining 62 thereof into contact with the outer lateral surface of the disc 2.

In this way, the caliper 6 illustrated in FIG. 1 provided on the carrier 5 to be movable is operated by a plurality of pistons (not illustrated) to sandwich the pair of friction pads 8 and 9 between the pistons and the pressing claw 173 from both sides in the disc axial direction, and press the friction pads 8 and 9 against both lateral surfaces of the disc 2. As a result, the caliper 6 applies frictional resistance to the disc 2 to generate a braking force. The caliper 6 is a so-called first type caliper that moves in the axial direction with respect to the carrier 5.

Here, as illustrated in FIG. 3, the return spring 11 is restricted from moving to the inner side when the contact plate part 141 of the contact part 103 thereof comes into contact with the surface portion 45 of the outer wall part 26. Therefore, when the outer friction pad 8 moves to the inner side with respect to the carrier 5 as described above, the return spring 11, which has been in a standby state until then, mainly elastically deforms the connection plate part 131 of the first extension part 101 and the second extension part 102 illustrated in FIG. 10 to be in an elastically deformed state. Thereby, the return spring 11 separates the fixing part 100 fixed to the friction pad 8 illustrated in FIG. 3 and the contact part 103 whose movement with respect to the carrier 5 is restricted in the disc axial direction.

Also, the return spring 12 is restricted from moving to the disc 2 side when the contact plate part 141 of the contact part 103 thereof comes into contact with the surface portion 47 of the outer wall part 27. Therefore, when the outer friction pad 8 moves to the disc 2 side with respect to the carrier 5 as described above, the return spring 12, which has been in a standby state until then, is elastically deformed similarly to the return spring 11 to be in an elastically deformed state. Thereby, the return spring 12 separates the fixing part 100 fixed to the friction pad 8 and the contact part 103 whose movement with respect to the carrier 5 is restricted in the disc axial direction.

When the pressure on the outer friction pad 8 due to the caliper 6 is released, the return spring 11, which has been in an elastically deformed state, returns the elastic deformation of the connection plate part 131 of the first extension part 101 and the second extension part 102 illustrated in FIG. 10, which has been mainly elastically deformed until then, back to a standby state. Then, the return spring 11 brings the fixing part 100 fixed to the friction pad 8 illustrated in FIG. 3 and the contact part 103 which is in contact with the carrier 5 closer to each other in the disc axial direction. Thereby, the outer friction pad 8 moves to the outer side with respect to the carrier 5 in the disc axial direction to separate the lining 62 from the disc 2.

Also, when the pressure on the outer friction pad 8 due to the caliper 6 is released, the return spring 12 which has been in the elastically deformed state also returns from the elastically deformed state to the standby state similarly to the return spring 11. Then, the return spring 12 brings the fixing part 100 fixed to the friction pad 8 and the contact part 103 which is in contact with the carrier 5 closer to each other in the disc axial direction. This also makes the outer friction pad 8 move to the outer side with respect to the carrier 5 in the disc axial direction, thereby separating the lining 62 from the disc 2.

Also, the return springs 13 and 14 illustrated in FIG. 1 attached to the inner friction pad 9 also operate in the same manner as the return springs 11 and 12 when the pressure on the inner friction pad 9 due to the caliper 6 is released. Then, the return springs 13 and 14 move the inner friction pad 9 to a side opposite to the disc 2, that is, to the inner side, in the disc axial direction with respect to the carrier 5, thereby separating the lining 62 from the disc 2.

Patent Document 1 described above describes a disc brake that uses a return spring that is integrally formed by punching out a steel plate having spring properties and then bending it using a method such as press working. When a user performs a maintenance on the disc brake such as replacing parts or washing the vehicle, if an edge portion of the return spring is exposed, there has been a likelihood of a decrease in maintainability due to fingers getting caught on the edge portion or the like. In recent years, although a large number of shapes of return springs have been developed to reduce a size of the disc brake, particularly due to such a reduction in size of the disc brake, there has been a likelihood that fingers may more easily get caught on the exposed edge portion of the return spring, thereby further decreasing maintainability.

In contrast, the return springs 11 and 12 of the first embodiment includes the fixing part 100 fixed to the friction pad 8, the first extension part 101 formed in a plate shape and extending from the fixing part 100 in a direction away from the friction pad 8, the second extension part 102 formed in a plate shape and extending from the first extension part 101 in a direction of pressing the friction pad 8, and the contact part 103 formed in a plate shape and extending from the second extension part 102 to come into contact with the carrier 5. Also, the return springs 13 and 14 have the same configuration as the return springs 11 and 12 except that they are fixed to the friction pad 9.

Then, if the return springs 11 to 14 having the same configuration are described using the return spring 11 as an example, the return spring 11 includes the edge portions 124 to 129, 134, 135, 145, and 146 which are surfaces each extending in a plate thickness direction of the first extension part 101, the second extension part 102, and the contact part 103. The return spring 11 includes the cover part 104 that covers at least a part of the edge portions 124, 126, 128, 134, and 145, and the cover part 105 that covers at least a part of the edge portions 125, 127, 129, 135, and 146. Therefore, the cover part 104 can suppress exposure of the edge portions 124, 126, 128, 134, and 145, and can suppress fingers getting caught on the edge portions 124, 126, 128, 134, and 145. Also, the cover part 105 can suppress exposure of the edge portions 125, 127, 129, 135, and 146, and can suppress fingers getting caught on the edge portions 125, 127, 129, 135, and 146. Therefore, maintainability of the disc brake 1 in which the return springs 11 to 14 are provided can be improved.

In the return springs 11 to 14 having the same configuration, the first extension part 101 is formed in an arcuate shape. Therefore, a local stress generated in the return springs 11 to 14 can be suppressed. Therefore, reliability of the return springs 11 to 14 can be improved.

If the return springs 11 to 14 having the same configuration are described using the return spring 11 as an example, the cover parts 104 and 105 thereof are provided to extend from at least one of the first extension part 101, the second extension part 102, and the contact part 103. Specifically, the cover parts 104 and 105 are provided in the return spring 11 to extend from the intermediate plate part 142 of the contact part 103. Therefore, the cover parts 104 and 105 can be formed integrally with the fixing part 100, the first extension part 101, the second extension part 102, and the contact part 103. Therefore, the return springs 11 to 14 can be manufactured easily and at a low cost, and an increase in man-hours for assembling them can also be suppressed.

If the return springs 11 to 14 having the same configuration are described using the return spring 11 as an example, the cover parts 104 and 105 are provided to extend not from a curved portion that affects a spring load that occurs, but rather from the flat plate-shaped intermediate plate part 142 having little influence on a spring load that occurs. Therefore, the return springs 11 to 14 can suppress an influence of forming the cover parts 104 and 105 on a spring load that occurs, that is, on a spring performance.

In the return springs 11 to 14 of the first embodiment, only one of the cover parts 104 and 105 may be provided. For example, of the cover parts 104 and 105, only the cover part disposed on the disc radially outer side may be provided. Also, for example, of the cover parts 104 and 105, only the cover part disposed on the disc radially inner side may be provided.

### Second Embodiment

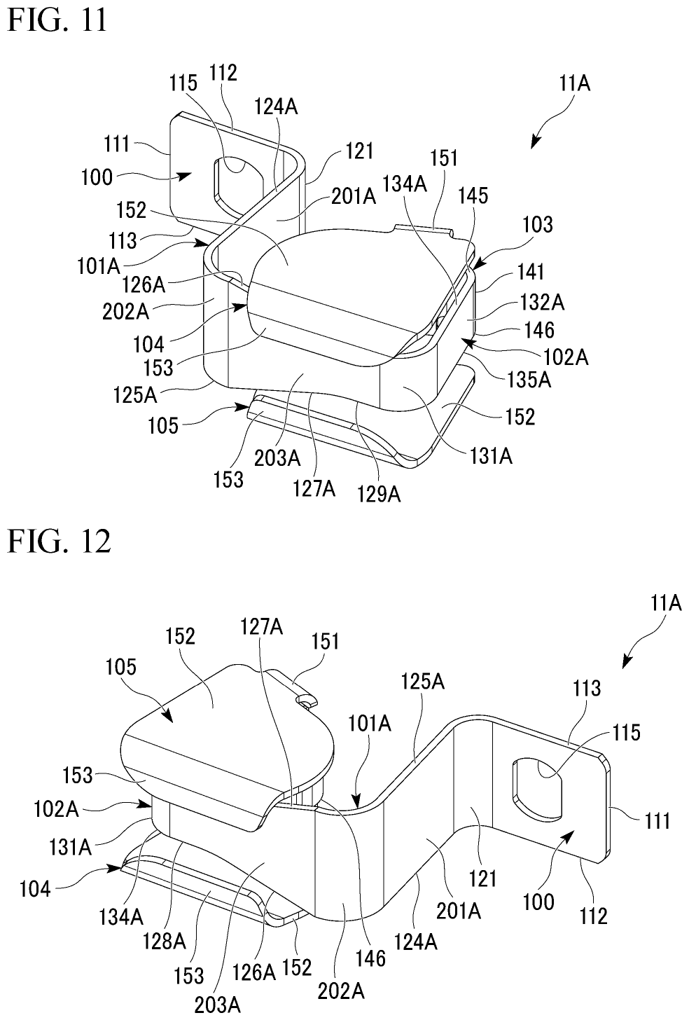

Next, a second embodiment will be described mainly on the basis of FIGS. 11 to 14, focusing on differences from the first embodiment. Further, parts common to those in the first embodiment will be denoted by the same terms and the same reference signs.

In the second embodiment, a return spring 11A is partially modified from the return spring 11 of the first embodiment. Return springs 12 to 14 are modified in the same manner.

As illustrated in FIGS. 11 to 13, the return spring 11A has a mirror-symmetrical shape, and includes a first extension part 101A that is modified from the first extension part 101, and a second extension part 102A that is modified from the second extension part 102.

The first extension part 101A also has a plate shape and extends from a fixing part 100 to one side in a plate thickness direction of the fixing part 100. The first extension part 101A has a substantially constant plate thickness and is partially curved in the plate thickness direction. The first extension part 101A includes a protruding plate part 121 similar to that of the first embodiment, a base end side extension plate part 201A, an intermediate plate part 202A (first curved part), and a distal end side extension plate part 203A (connection part).

The base end side extension plate part 201A has a flat plate shape, and extends from an end portion of the protruding plate part 121 on a side opposite to the fixing part 100 to a side opposite to the fixing part 100 in the plate thickness direction of the fixing part 100. As illustrated in FIG. 14, the base end side extension plate part 201A forms an acute angle of less than 90 degrees with the fixing part 100. Therefore, the base end side extension plate part 201A approaches an edge portion 111 in a direction in which edge portions 112 and 113 illustrated in FIGS. 11 and 12 extend toward an extension distal end side.

The intermediate plate part 202A has a curved plate shape that is curved in an arcuate shape in a plate thickness direction thereof. The intermediate plate part 202A protrudes from an end portion of the base end side extension plate part 201A on a side opposite to the protruding plate part 121 to a side opposite to the edge portion 111 in a direction in which the edge portions 112 and 113 extend. The intermediate plate part 202A is curved such that a center of curvature thereof is positioned on the fixing part 100 side in the plate thickness direction of the fixing part 100 with respect to the intermediate plate part 202A.

The distal end side extension plate part 203A has a flat plate shape, and extends from an end portion of the intermediate plate part 202A on a side opposite to the base end side extension plate part 201A in a direction opposite to the edge portion 111 in a direction in which the edge portions 112 and 113 extend. As illustrated in FIG. 14, the distal end side extension plate part 203A extends in a direction of the fixing part 100 and is parallel to the fixing part 100. The distal end side extension plate part 203A forms an acute angle of less than 90 degrees with the base end side extension plate part 201A.

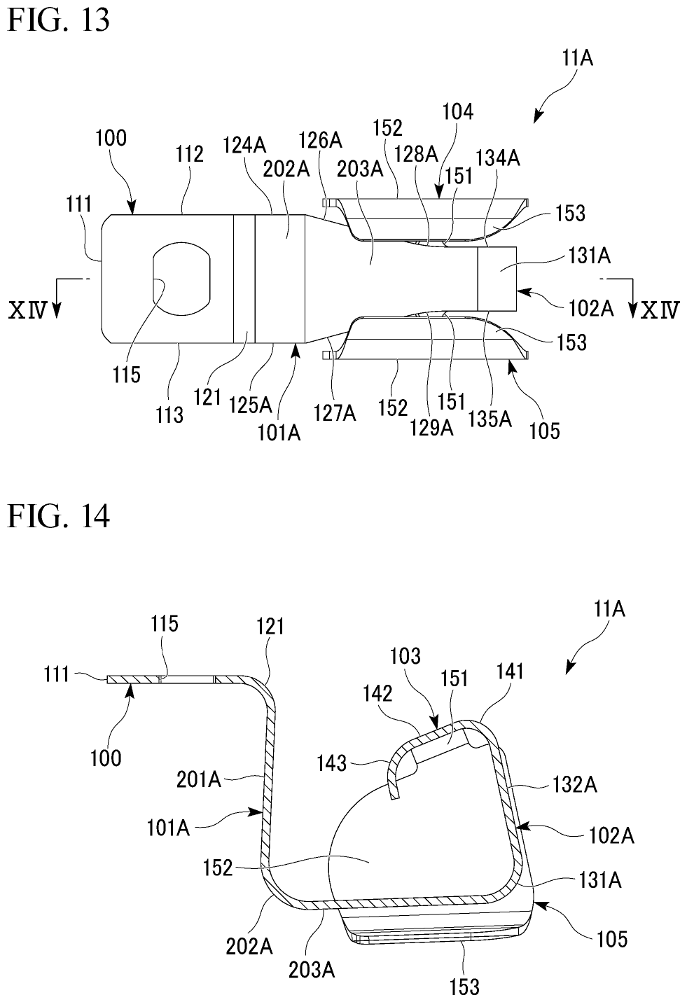

As illustrated in FIG. 11, FIG. 12, or FIG. 13, the first extension part 101A has an edge portion 124A, an edge portion 125A, an edge portion 126A, an edge portion 127A, an edge portion 128A, and an edge portion 129A. All the edge portions 124A to 129A are surfaces extending in a plate thickness direction of the first extension part 101A.

As illustrated in FIG. 11, the edge portion 124A is formed on the protruding plate part 121, the base end side extension plate part 201A, and the intermediate plate part 202A. The edge portion 124A extends from an end edge portion on a side opposite to the edge portion 111 in a direction in which the edge portion 112 extends. The edge portion 124A is planar and disposed on the same plane as the edge portion 112.

As illustrated in FIG. 12, the edge portion 125A is formed on the protruding plate part 121, the base end side extension plate part 201A, and the intermediate plate part 202A. The edge portion 125A extends from an end edge portion on a side opposite to the edge portion 111 in a direction in which the edge portion 113 extends. The edge portion 125A is planar and disposed on the same plane as the edge portion 113. Therefore, the edge portion 125A faces in a direction opposite to the edge portion 124A and is parallel to the edge portion 124A.

As illustrated in FIG. 13, the edge portion 126A is formed on the distal end side extension plate part 203A. The edge portion 126A extends from an end edge portion of the edge portion 124A on a side opposite to the edge portion 112. The edge portion 126A is planar and inclined with respect to the edge portion 124A.

The edge portion 127A is formed on the distal end side extension plate part 203A. The edge portion 127A extends from an end edge portion of the edge portion 125A on a side opposite to the edge portion 113. The edge portion 127A is planar and inclined with respect to the edge portion 125A.

The edge portions 126A and 127A face each other in opposite directions, and are inclined with respect to the edge portions 124A and 125A so that they approach each other with distance away from the edge portions 124A and 125A.

The edge portion 128A is formed on the distal end side extension plate part 203A. The edge portion 128A extends from an end edge portion of the edge portion 126A on a side opposite to the edge portion 124A. The edge portion 128A has a curved surface shape.

The edge portion 129A is formed on the distal end side extension plate part 203A. The edge portion 129A extends from an end edge portion of the edge portion 127A on a side opposite to the edge portion 125A. The edge portion 129A has a curved surface shape. The edge portion 129A faces in a direction opposite to the edge portion 128A.

The second extension part 102A has a plate shape, and extends from an end portion of the distal end side extension plate part 203A on a side opposite to the intermediate plate part 202A to just short of the fixing part 100 in the plate thickness direction of the fixing part 100 as illustrated in FIG. 14. The second extension part 102A has a substantially constant plate thickness and is partially curved in the plate thickness direction. The second extension part 102A includes a connection plate part 131A (second curved part) and an intermediate extension plate part 132A.

The connection plate part 131A protrudes to the fixing part 100 side in the plate thickness direction of the fixing part 100 from an end portion of the distal end side extension plate part 203A on a side opposite to the intermediate plate part 202A. The connection plate part 131A has a curved plate shape that is curved in an arcuate shape in a plate thickness direction thereof. The connection plate part 131A is curved such that a center of curvature thereof is positioned on the edge portion 111 side in a direction in which the edge portions 112 and 113 illustrated in FIGS. 11 and 12 extend with respect to the connection plate part 131A. The connection plate part 131A has a radius of curvature smaller than that of the connection plate part 131 of the return spring 11. The connection plate part 131A has a length in a circumferential direction shorter than that of the connection plate part 131 of the return spring 11.

As illustrated in FIG. 11, the intermediate extension plate part 132A has a flat plate shape and extends from an end portion of the connection plate part 131A on a side opposite to the distal end side extension plate part 203A. As illustrated in FIG. 14, the intermediate extension plate part 132A extends to approach the fixing part 100 in the plate thickness direction of the fixing part 100 from the connection plate part 131A. The intermediate extension plate part 132A approaches the edge portion 111 in a direction in which the edge portions 112 and 113 illustrated in FIGS. 11 and 12 extend toward an extension distal end side. As illustrated in FIG. 14, the intermediate extension plate part 132A forms an acute angle of less than 90 degrees with the distal end side extension plate part 203A. The intermediate extension plate part 132A has a length in the extension direction longer than that of the intermediate extension plate part 132 of the return spring 11.

As illustrated in FIG. 11, the second extension part 102A has an edge portion 134A and an edge portion 135A. The edge portions 134A and 135A are formed on the connection plate part 131A and the intermediate extension plate part 132A. Both the edge portions 134A and 135A are surfaces extending in a plate thickness direction of the second extension part 102A.

As illustrated in FIG. 13, the edge portion 134A extends from an end edge portion of the edge portion 128A on a side opposite to the edge portion 126A. The edge portion 134A is planar and extends parallel to the edge portion 124A. The edge portion 128A is slightly curved to gently connect the edge portion 126A and the edge portion 134A.

The edge portion 135A extends from an end edge portion of the edge portion 129A on a side opposite to the edge portion 127A. The edge portion 135A is planar and extends parallel to the edge portion 125A. The edge portion 129A is slightly curved to gently connect the edge portion 127A and the edge portion 135A. The edge portion 135A faces in a direction opposite to the edge portion 134A and is parallel to the edge portion 134A. A distance between the edge portions 134A and 135A is smaller than a distance between the edge portions 124A and 125A.

As illustrated in FIG. 14, a contact part 103 has the same shape as that in the first embodiment. The contact part 103 extends from an end portion of the intermediate extension plate part 132A on a side opposite to the connection plate part 131A toward the edge portion 111 in a direction in which the edge portions 112 and 113 illustrated in FIGS. 11 and 12 extend. As illustrated in FIG. 14, the contact part 103 is disposed on the same side as the first extension part 101A and the second extension part 102A with respect to the fixing part 100 in the plate thickness direction of the fixing part 100.

In the contact part 103, a contact plate part 141 protrudes from an end portion of the intermediate extension plate part 132A on a side opposite to the connection plate part 131A toward the edge portion 111 in a direction in which the edge portions 112 and 113 illustrated in FIGS. 11 and 12 extend. The contact plate part 141 is curved such that a center of curvature thereof is positioned on a side opposite to the fixing part 100 in the plate thickness direction of the fixing part 100 with respect to the contact plate part 141.

An intermediate plate part 142 approaches the edge portion 111 in a direction in which the edge portions 112 and 113 illustrated in FIGS. 11 and 12 extend from an end portion of the contact plate part 141 on a side opposite to the intermediate extension plate part 132A, and then extends in a direction away from the fixing part 100 in the plate thickness direction of the fixing part 100 illustrated in FIG. 14. The intermediate plate part 142 forms an acute angle of less than 90 degrees with the intermediate extension plate part 132A.

The inwardly extending plate part 143 extends from an end portion of the intermediate plate part 142 on a side opposite to the contact plate part 141 to a side opposite to the fixing part 100 in the plate thickness direction of the fixing part 100. The inwardly extending plate part 143 is curved such that a center of curvature thereof is positioned on a side opposite to the edge portion 111 in a direction in which the edge portions 112 and 113 illustrated in FIGS. 11 and 12 extend with respect to the inwardly extending plate part 143.

In the contact part 103, an edge portion 145 illustrated in FIG. 11 extends from an end edge portion of the edge portion 134A on a side opposite to the edge portion 128A illustrated in FIG. 13. The edge portion 145 illustrated in FIG. 11 is disposed on the same plane as the edge portion 134A. In the contact part 103, an edge portion 146 extends from an end edge portion of the edge portion 135A on a side opposite to the edge portion 129A. The edge portion 146 is disposed on the same plane as the edge portion 135A.

In each of the fixing part 100, the first extension part 101A, the second extension part 102A, and the contact part 103, a line in the plate thickness direction passes through one plane. The edge portions 112, 113, 124A, 125A, 134A, 135A, 145, and 146 are parallel to the planes, respectively.

Cover parts 104 and 105 illustrated in FIGS. 11 to 13 are provided in the return spring 11A to extend from at least one of the first extension part 101A, the second extension part 102A, and the contact part 103. Specifically, the cover parts 104 and 105 are provided in the return spring 11A to extend from the intermediate plate part 142 of the contact part 103 similarly to those in the return spring 11.

As a cover plate part 152 of the cover part 105 illustrated in FIG. 14, the cover plate parts 152 of the cover parts 104 and 105 both extend to a side of the first extension part 101A and the second extension part 102A opposite to the fixing part 100 in the plate thickness direction of the fixing part 100. As the cover plate part 152 of the cover part 105 illustrated in FIG. 14, the cover plate parts 152 of the cover parts 104 and 105 overlap the entire second extension part 102A, a portion of the distal end side extension plate part 203A of the first extension part 101A on the second extension part 102A side, and a distal end portion of the inwardly extending plate part 143 of the contact part 103 on a side opposite to the intermediate plate part 142 in position in a direction in which the edge portions 134A and 135A illustrated in FIG. 11, both of which are surfaces of the second extension part 102A, extend.

The cover plate part 152 of the cover part 104 illustrated in FIGS. 11 to 13 covers at least a part of the edge portions 124A, 126A, 128A, 134A, and 145 illustrated in FIG. 11, FIG. 12, or FIG. 13. Specifically, the cover plate part 152 of the cover part 104 faces and covers a part of the edge portion 126A on the edge portion 128A side, the entire edge portion 128A, the entire edge portion 134A, and a distal end portion of the edge portion 145 on a side opposite to the edge portion 134A in a direction perpendicular to the edge portion 134A.

The cover plate part 152 of the cover part 105 illustrated in FIGS. 11 to 14 covers at least a part of the edge portions 125A, 127A, 129A, 135A, and 146 illustrated in FIG. 11, FIG. 12, or FIG. 13. Specifically, the cover plate part 152 of the cover part 105 faces and covers a part of the edge portion 127A on the edge portion 129A side, the entire edge portion 129A, the entire edge portion 135A, and a distal end portion of the edge portion 146 on a side opposite to the edge portion 135A in a direction perpendicular to the edge portion 135A.

The return spring 11A is also attached to the lug part 72 of the outer friction pad 8 illustrated in FIGS. 4 to 6 at the fixing part 100 similarly to the return spring 11. With the return spring 11A attached, the friction pad 8 is supported by recessed parts 51 and 52 of a pair of outer wall parts 26 and 27 of a carrier 5 as in the first embodiment. Then, in the return spring 11A, the base end side extension plate part 201A of the first extension part 101A extends from the fixing part 100 in a direction away from the friction pad 8 in a plate thickness direction of the friction pad 8. At that time, in the return spring 11A, the distal end side extension plate part 203A of the first extension part 101A extends in a direction away from the fixing part 100 to a disc rotation direction first side. The second extension part 102A of the return spring 11A extends from the distal end side extension plate part 203A of the first extension part 101A to an inner side in the plate thickness direction of the friction pad 8. That is, the second extension part 102A of the return spring 11A extends from the distal end side extension plate part 203A of the first extension part 101A in a direction in which the friction pad 8 is pressed by a caliper 6.

In the return spring 11A, the second extension part 102A, the contact part 103, and the cover parts 104 and 105, all of which are on the disc rotation direction first side with respect to the fixing part 100, overlap the outer wall part 26 in position in a disc rotation direction and a disc radial direction. The contact part 103 of the return spring 11A extends from the second extension part 102A and comes into contact with a surface portion 45 of the outer wall part 26 of the carrier 5 at the contact plate part 141. At that time, the contact part 103 of the return spring 11A extends in a direction away from the intermediate extension plate part 132A of the second extension part 102A to a disc rotation direction second side.

In the return spring 11A, the edge portions 124A to 129A, 134A, 135A, 145, and 146 are surfaces facing in the disc radial direction. In the return spring 11A, the cover part 104 covers a part of the edge portion 126A, the entire edge portions 128A and 134A, and a distal end portion of the edge portion 145 from a disc radially outer side. Also, the cover part 105 covers a part of the edge portion 127A, the entire edge portions 129A and 135A, and a distal end portion of the edge portion 146 from a disc radially inner side.

The return spring 11A is restricted from moving to a disc 2 side when the contact plate part 141 of the contact part 103 thereof comes into contact with the surface portion 45 of the outer wall part 26. Therefore, when the outer friction pad 8 moves to the disc 2 side with respect to the carrier 5 due to the pressure from the caliper 6, the return spring 11A, which has been in a standby state, mainly elastically deforms the first extension part 101A to be in an elastically deformed state. Thereby, the return spring 11A separates the fixing part 100 fixed to the friction pad 8 and the contact part 103 whose movement with respect to the carrier 5 is restricted in a disc axial direction.

Also, when the pressure on the outer friction pad 8 due to the caliper 6 is released, the return spring 11A, which has been in an elastically deformed state, returns the elastic deformation of the first extension part 101A, which has been mainly elastically deformed until then, back to a standby state. Then, the return spring 11A brings the fixing part 100 fixed to the friction pad 8 and the contact part 103 which is in contact with the carrier 5 closer to each other in the disc axial direction. Thereby, the outer friction pad 8 moves to a side opposite to the disc 2 with respect to the carrier 5 in the disc axial direction to separate a lining 62 thereof from the disc 2.

The return springs 12 to 14 are also modified to be common parts having the same shape as the return spring 11A, and are attached to the friction pads 8 and 9 as in the first embodiment. The modified return springs 12 to 14 also operate in the same manner as the return spring 11A.

The return spring 11A of the second embodiment also includes the edge portions 124A to 129A, 134A, 135A, 145, and 146 which are surfaces each extending in a plate thickness direction of the first extension part 101A, the second extension part 102A, and the contact part 103. Then, the return spring 11A includes the cover part 104 that covers at least a part of the edge portions 124A, 126A, 128A, 134A, and 145, and the cover part 105 that covers at least a part of the edge portions 125A, 127A, 129A, 135A, and 146. Therefore, the cover part 104 can suppress exposure of the edge portions 124A, 126A, 128A, 134A, and 145, and can suppress fingers getting caught on the edge portions 124A, 126A, 128A, 134A, and 145. Also, the cover part 105 can suppress exposure of the edge portions 125A, 127A, 129A, 135A, and 146, and can suppress fingers getting caught on the edge portions 125A, 127A, 129A, 135A, and 146. Therefore, maintainability of a disc brake 1 in which the return spring 11A and the like are provided can be improved.

Also in the return spring 11A, the cover parts 104 and 105 are provided to extend from at least one of the first extension part 101A, the second extension part 102A, and the contact part 103. Specifically, the cover parts 104 and 105 of the return spring 11A extend from the intermediate plate part 142 of the contact part 103. Therefore, the cover parts 104 and 105 can be formed integrally with the fixing part 100, the first extension part 101A, the second extension part 102A, and the contact part 103. Therefore, the return spring 11A can be manufactured easily and at a low cost, and an increase in man-hours for assembling them can also be suppressed.

Also in the return spring 11A, the cover parts 104 and 105 are provided to extend not from a curved portion that affects a spring load that occurs, but rather from the flat plate-shaped intermediate plate part 142 having little influence on a spring load that occurs. Therefore, the return spring 11A can also reduce an influence of forming the cover parts 104 and 105 on a spring load that occurs, that is, on a spring performance.

Also, the return spring 11A includes the distal end side extension plate part 203A provided to connect the protruding plate part 121, the base end side extension plate part 201A, and the intermediate plate part 202A of the first extension part 101A to the second extension part 102A in a direction different from directions of the protruding plate part 121, the base end side extension plate part 201A, the intermediate plate part 202A, and the second extension part 102A. Therefore, the fixing part 100, the protruding plate part 121, the base end side extension plate part 201A, the intermediate plate part 202A, the distal end side extension plate part 203A, the second extension part 102A, and the contact part 103 can be easily formed integrally. Therefore, the return spring 11A can be manufactured easily and at a low cost.

Also, the return spring 14A includes at least one, specifically both, of the intermediate plate part 202A, which is the first curved part, provided in the first extension part 101A to be connected to the distal end side extension plate part 203A, and the connection plate part 131A, which is the second curved part, provided in the second extension part 102F to be connected to the distal end side extension plate part 203A. Therefore, the fixing part 100, the protruding plate part 121, the base end side extension plate part 201A, the intermediate plate part 202A, the distal end side extension plate part 203A, the second extension part 102A, and the contact part 103 can be easily formed integrally. Therefore, the return spring 11A can be manufactured easily and at a low cost.

Also, the return spring 11A is configured such that the cover parts 104 and 105 are provided at a position overlapping at least one of the intermediate plate part 202A which is the first curved part and the connection plate part 131A which is the second curved part, specifically the connection plate part 131A, in the plate thickness direction. Therefore, the cover parts 104 and 105 can suppress exposure of at least one of the intermediate plate part 202A and the connection plate part 131A, specifically the connection plate part 131A, and can suppress fingers getting caught on the intermediate plate part 202A and the connection plate part 131A. Therefore, maintainability of the disc brake 1 in which the return spring 11A and the like are provided can be improved.

Also, the return spring 11A is configured such that the cover parts 104 and 105 are provided at a predetermined distance from the intermediate plate part 202A which is the first curved part or the connection plate part 131A which is the second curved part, specifically, from both the intermediate plate part 202A and the connection plate part 131A. Therefore, the cover parts 104 and 105 can be easily formed integrally with the fixing part 100, the protruding plate part 121, the base end side extension plate part 201A, the intermediate plate part 202A, the distal end side extension plate part 203A, the second extension part 102A, and the contact part 103. Therefore, the return spring 14A can be manufactured easily and at a low cost.

Also in the return spring 11A and the like of the second embodiment, only one of the cover parts 104 and 105 may be provided as in the first embodiment.

### Third Embodiment

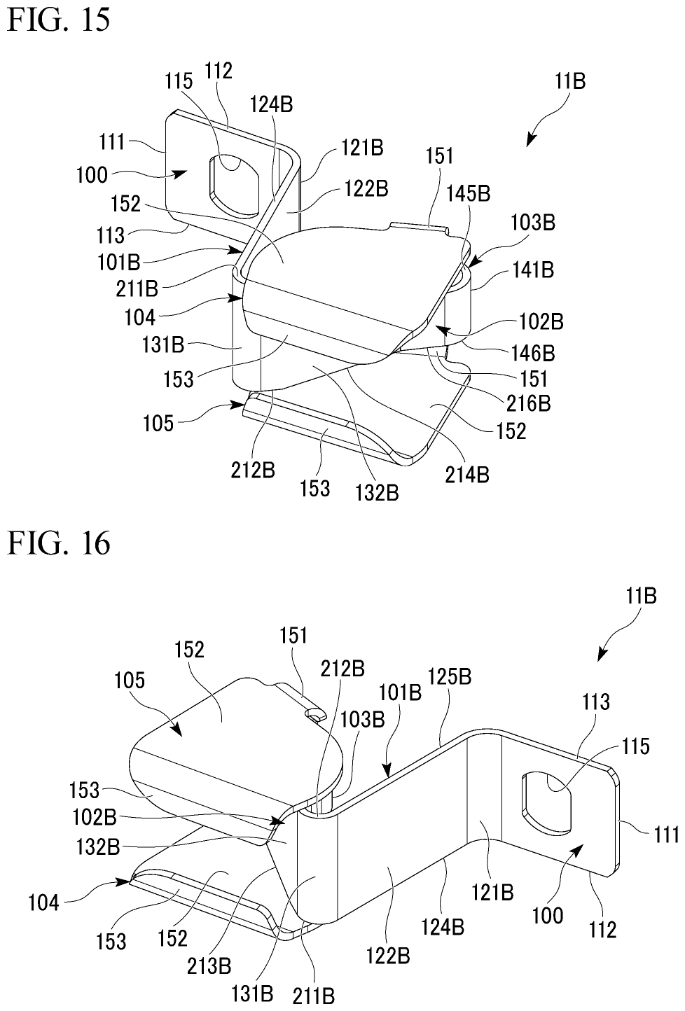

Next, a third embodiment will be described mainly on the basis of FIGS. 15 to 18, focusing on differences from the first embodiment. Further, parts common to those in the first embodiment will be denoted by the same terms and the same reference signs.

In the third embodiment, a return spring 11B is partially modified from the return spring 11 of the first embodiment. Return springs 12 to 14 are modified in the same manner.

As illustrated in FIGS. 15 to 17, the return spring 11B has a mirror-symmetrical shape, and includes a first extension part 101B that is modified from the first extension part 101, a second extension part 102B that is modified from the second extension part 102, and a contact part 103B that is modified from the contact part 103.

The first extension part 101B also has a plate shape and extends from a fixing part 100 to one side in a plate thickness direction of the fixing part 100. The first extension part 101B has a substantially constant plate thickness and is partially curved in the plate thickness direction. The first extension part 101B includes a protruding plate part 121B and an extension plate part 122B.

As illustrated in FIGS. 15 and 16, the protruding plate part 121B has a curved plate shape that is curved in an arcuate shape in a plate thickness direction thereof. The protruding plate part 121B has the same radius of curvature as the protruding plate part 121 of the return spring 11, and has a length in a circumferential direction longer than that of the protruding plate part 121. The protruding plate part 121B protrudes from an end portion of the fixing part 100 on a side opposite to an edge portion 111 to one side in the plate thickness direction of the fixing part 100. The protruding plate part 121B is curved such that a center of curvature thereof is positioned on the edge portion 111 side in a direction in which edge portions 112 and 113 extend with respect to the protruding plate part 121B.

The extension plate part 122B has a flat plate shape and extends from an end portion of the protruding plate part 121B on a side opposite to the fixing part 100 to a side opposite to the fixing part 100 in the plate thickness direction of the fixing part 100. As illustrated in FIG. 18, the extension plate part 122B forms an obtuse angle of larger than 90 degrees with the fixing part 100. The extension plate part 122B becomes further away from the edge portion 111 in a direction in which the edge portions 112 and 113 illustrated in FIGS. 15 and 16 extend toward an extension distal end side.

As illustrated in FIG. 16, the first extension part 101B includes an edge portion 124B and an edge portion 125B. Both the edge portions 124B and 125B are surfaces extending in a thickness direction of the first extension part 101B.

The edge portion 124B is formed on the protruding plate part 121B and the extension plate part 122B. The edge portion 124B extends from an end edge portion on a side opposite to the edge portion 111 in a direction in which the edge portion 112 extends. The edge portion 124B is planar and disposed on the same plane as the edge portion 112.

The edge portion 125B is formed on the protruding plate part 121B and the extension plate part 122B. The edge portion 125B extends from an end edge portion on a side opposite to the edge portion 111 in a direction in which the edge portion 113 extends. The edge portion 125B is planar and is disposed on the same plane as the edge portion 113. Therefore, the edge portion 125B faces in a direction opposite to the edge portion 124B and is parallel to the edge portion 124B.

The second extension part 102B also has a plate shape, and extends from an end portion of the extension plate part 122B on a side opposite to the protruding plate part 121B to just short of the fixing part 100 in the plate thickness direction of the fixing part 100 as illustrated in FIG. 18. The second extension part 102B has a substantially constant plate thickness and is partially curved in the plate thickness direction. The second extension part 102B includes a connection plate part 131B and an intermediate extension plate part 132B.

The connection plate part 131B has a curved plate shape that is curved in an arcuate shape in a plate thickness direction thereof. The connection plate part 131B extends from an end portion of the extension plate part 122B on a side opposite to the protruding plate part 121B to a side opposite to the edge portion 111 in a direction in which the edge portions 112 and 113 illustrated in FIGS. 15 and 16 extend. The connection plate part 131B is curved such that a center of curvature thereof is positioned on the fixing part 100 side in the plate thickness direction of the fixing part 100 with respect to the connection plate part 131B.

The intermediate extension plate part 132B has a flat plate shape and extends from an end portion of the connection plate part 131B on a side opposite to the extension plate part 122B. The intermediate extension plate part 132B extends to approach the fixing part 100 in the plate thickness direction of the fixing part 100 from the connection plate part 131B. The intermediate extension plate part 132B becomes further away from the edge portion 111 in a direction in which the edge portions 112 and 113 extend toward an extension distal end side. As illustrated in FIG. 18, the intermediate extension plate part 132B forms an acute angle of less than 90 degrees with the extension plate part 122B.

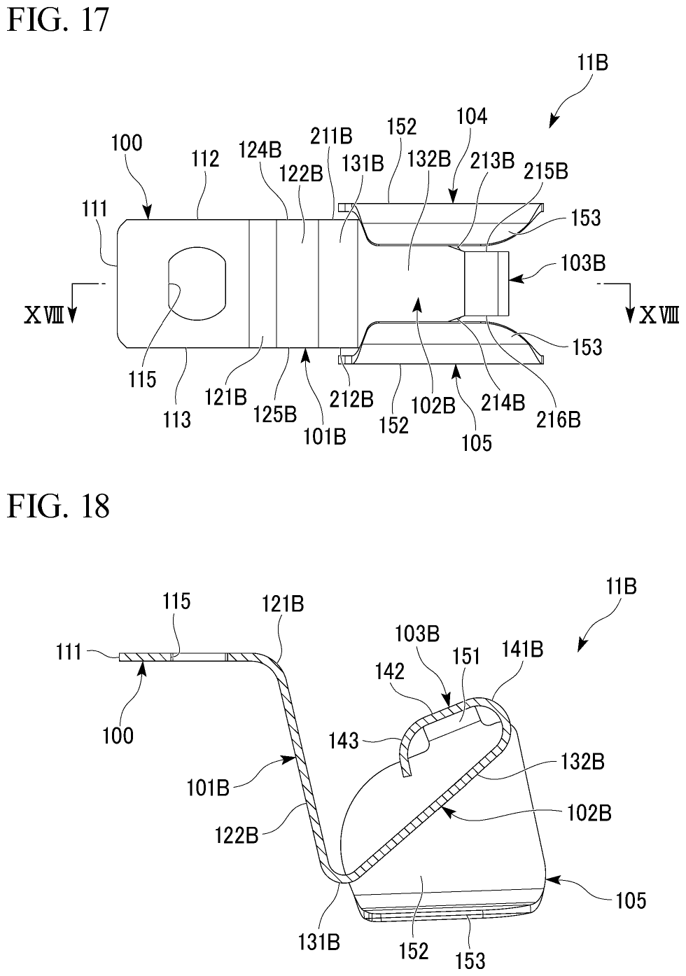

As illustrated in FIG. 17, the second extension part 102B includes an edge portion 211B, an edge portion 212B, an edge portion 213B, an edge portion 214B, an edge portion 215B, and an edge portion 216B. All the edge portions 211B to 216B are surfaces extending in a plate thickness direction of the second extension part 102B.

As illustrated in FIG. 16, the edge portions 211B and 212B are formed on the connection plate part 131B.

The edge portion 211B extends from an end edge portion of the edge portion 124B on a side opposite to the edge portion 112. The edge portion 211B is planar and disposed on the same plane as the edge portion 124B.

The edge portion 212B extends from an end edge portion of the edge portion 125B on a side opposite to the edge portion 113. The edge portion 212B is planar and disposed on the same plane as the edge portion 125B. Therefore, the edge portion 212B faces in a direction opposite to the edge portion 211B and is parallel to the edge portion 211B.

As illustrated in FIG. 17, the edge portions 213B and 214B are formed on a portion of the intermediate extension plate part 132B on the connection plate part 131B side.

The edge portion 213B extends from an end edge portion of the edge portion 211B on a side opposite to the edge portion 124B. The edge portion 213B is planar and inclined with respect to the edge portion 211B.

The edge portion 214B extends from an end edge portion of the edge portion 212B on a side opposite to the edge portion 125B. The edge portion 214B is planar and inclined with respect to the edge portion 212B.

The edge portions 213B and 214B face each other in opposite directions, and are inclined with respect to the edge portions 211B and 212B so that they approach each other with distance away from the edge portions 211B and 212B.

The edge portions 215B and 216B are formed on a portion of the intermediate extension plate part 132B on a side opposite to the connection plate part 131B. The edge portion 215B extends from an end edge portion of the edge portion 213B on a side opposite to the edge portion 211B. The edge portion 215B is planar and extends parallel to the edge portion 211B.

The edge portion 216B extends from an end edge portion of the edge portion 214B on a side opposite to the edge portion 212B. The edge portion 216B is planar and extends parallel to the edge portion 212B. Therefore, the edge portion 216B faces in a direction opposite to the edge portion 215B and is parallel to the edge portion 215B. A distance between the edge portions 215B and 216B is smaller than a distance between the edge portions 211B and 212B.

The contact part 103B also has a plate shape, and as illustrated in FIG. 18, includes a contact plate part 141B that is partially different from the contact plate part 141 of the return spring 11. The contact plate part 141B has a curved plate shape that is curved in a plate thickness direction thereof. The contact plate part 141B has the same radius of curvature as the contact plate part 141 of the return spring 11, and has a length in a circumferential direction longer than that of the contact plate part 141. The contact plate part 141B extends from an end portion of the intermediate extension plate part 132B on a side opposite to the connection plate part 131B to the fixing part 100 side in the plate thickness direction of the fixing part 100. The contact plate part 141B is curved such that a center of curvature thereof is positioned on the edge portion 111 side in a direction in which the edge portions 112 and 113 illustrated in FIGS. 15 and 16 extend with respect to the contact plate part 141B.

As illustrated in FIG. 18, an intermediate plate part 142 of the contact part 103B extends from an end portion of the contact plate part 141B on a side opposite to the intermediate extension plate part 132B. The intermediate plate part 142 of the contact part 103B forms an acute angle of less than 90 degrees with the intermediate extension plate part 132B, which is smaller than an angle formed by the intermediate plate part 142 and the intermediate extension plate part 132 in the return spring 11. An angle formed by the intermediate plate part 142 and the fixing part 100 in the return spring 11B is equal to an angle formed by the intermediate plate part 142 and the fixing part 100 in the return spring 11.

As illustrated in FIG. 15, the contact part 103B has an edge portion 145B and an edge portion 146B. The edge portions 145B and 146B are formed on the contact plate part 141B, the intermediate plate part 142, and the inwardly extending plate part 143 illustrated in FIG. 18. Both the edge portions 145B and 146B are surfaces extending in a thickness direction of the contact part 103B.

The edge portion 145B illustrated in FIG. 15 extends from an end edge portion of the edge portion 215B on a side opposite to the edge portion 213B illustrated in FIG. 17. The edge portion 145B illustrated in FIG. 15 is planar and is disposed on the same plane as the edge portion 215B illustrated in FIG. 17.

The edge portion 146B illustrated in FIG. 15 extends from an end edge portion of the edge portion 216B on a side opposite to the edge portion 214B illustrated in FIG. 17. The edge portion 146B illustrated in FIG. 15 is planar and disposed on the same plane as the edge portion 216B illustrated in FIG. 17. Therefore, the edge portion 146B illustrated in FIG. 15 faces in a direction opposite to the edge portion 145B and is parallel to the edge portion 145B.

In each of the fixing part 100, the first extension part 101B, the second extension part 102B, and the contact part 103B, a line in the plate thickness direction passes through one plane. The edge portions 112, 113, 124B, 125B, 211B, 212B, 215B, 216B, 145B, and 146B are parallel to the planes, respectively.

In the return spring 11B, cover parts 104 and 105 are provided to extend from at least one of the first extension part 101B, the second extension part 102B, and the contact part 103B. Specifically, the cover parts 104 and 105 of the return spring 11B extend from the intermediate plate part 142 of the contact part 103B as in the return spring 11.

Cover plate parts 152 of the cover parts 104 and 105, as the cover plate part 152 of the cover part 105 illustrated in FIG. 18, both extend to a side of the first extension part 101B and the second extension part 102B opposite to the fixing part 100 in the plate thickness direction of the fixing part 100. As the cover plate part 152 of the cover part 105 illustrated in FIG. 18, the cover plate parts 152 of the cover parts 104 and 105 overlap a part of the connection plate part 131B on the intermediate extension plate part 132B side, the intermediate extension plate part 132B, a part of the contact plate part 141B on the intermediate extension plate part 132B side, and a distal end portion of the inwardly extending plate part 143 on a side opposite to the intermediate plate part 142 in position in a direction in which the edge portions 215B and 216B illustrated in FIG. 17, both of which are surfaces of the second extension part 102B, extend.

The cover plate part 152 of the cover part 104 covers at least a part of the edge portions 124B, 211B, 213B, 215B, and 145B. Specifically, the cover plate part 152 of the cover part 104 faces and covers a part of the edge portion 211B on the edge portion 213B side, the entire edge portion 213B, the entire edge portion 215B, a part of the edge portion 145B on the edge portion 215B side, and a distal end portion of the edge portion 145B on a side opposite to the edge portion 215B in a direction perpendicular to the edge portion 215B.

The cover plate part 152 of the cover part 105 covers at least a part of the edge portions 125B, 212B, 214B, 216B, and 146B. Specifically, the cover plate part 152 of the cover part 105 faces and covers a part of the edge portion 212B on the edge portion 214B side, the entire edge portion 214B, the entire edge portion 216B, a part of the edge portion 146B on the edge portion 216B side, and a distal end portion of the edge portion 146B on a side opposite to the edge portion 216B in a direction perpendicular to the edge portion 216B.

The return spring 11B is also attached to the lug part 72 of the outer friction pad 8 illustrated in FIGS. 4 to 6 at the fixing part 100 similarly to the return spring 11. With the return spring 11B attached, the friction pad 8 is supported by recessed parts 51 and 52 of a pair of outer wall parts 26 and 27 of a carrier 5 as in the first embodiment. Then, the first extension part 101B of the return spring 11B extends from the fixing part 100 in a direction away from the friction pad 8 in a plate thickness direction of the friction pad 8. At that time, the first extension part 101B of the return spring 11B extends in a direction away from the fixing part 100 to a disc rotation direction first side. The second extension part 102B of the return spring 11B extends from the first extension part 101B to an inner side in the plate thickness direction of the friction pad 8. That is, the second extension part 102B of the return spring 11B extends from the first extension part 101B in a direction in which the friction pad 8 is pressed by a caliper 6.

In the return spring 11B, the second extension part 102B, the contact part 103B, and the cover parts 104 and 105, all of which are on the disc rotation direction first side with respect to the fixing part 100, overlap the outer wall part 26 in position in a disc rotation direction and a disc radial direction. The contact part 103B of the return spring 11B extends from the second extension part 102B and comes into contact with a surface portion 45 of the outer wall part 26 of the carrier 5 at the contact plate part 141B. At that time, the contact part 103B of the return spring 11B extends to a disc rotation direction second side from the intermediate extension plate part 132B of the second extension part 102B.

In the return spring 11B, the edge portions 124B, 125B, 211B to 216B, 145B, and 146B are surfaces facing in the disc radial direction. In the return spring 11B, the cover part 104 covers a part of the edge portion 211B, the entire edge portion 213B, the entire edge portion 215B, and a base end portion and a distal end portion of the edge portion 145B from a disc radially outer side. Also, the cover part 105 covers a part of the edge portion 212B, the entire edge portion 214B, the entire edge portion 216B, and a base end portion and a distal end portion of the edge portion 146B from a disc radially inner side.

The return spring 11B is restricted from moving to a disc 2 side when the contact plate part 141B of the contact part 103B thereof comes into contact with the surface portion 45 of the outer wall part 26. Therefore, when the outer friction pad 8 moves to the disc 2 side with respect to the carrier 5 due to the pressure from the caliper 6, the return spring 11B, which has been in a standby state, mainly elastically deforms the first extension part 101B and the second extension part 102B to be in an elastically deformed state. Thereby, the return spring 11B separates the fixing part 100 fixed to the friction pad 8 and the contact part 103B whose movement with respect to the carrier 5 is restricted in a disc axial direction.

Also, when the pressure due to the caliper 6 is released, the return spring 11B, which has been in an elastically deformed state, returns the elastic deformation of the first extension part 101B and the second extension part 102B, which have been mainly elastically deformed, back to a standby state. Then, the return spring 11B brings the fixing part 100 fixed to the friction pad 8 and the contact part 103 which is in contact with the carrier 5 closer to each other in the disc axial direction. Thereby, the outer friction pad 8 moves to a side opposite to the disc 2 with respect to the carrier 5 in the disc axial direction to separate a lining 62 thereof from the disc 2.

The return springs 12 to 14 are also modified to be common parts having the same shape as the return spring 11B, and are attached to the friction pads 8 and 9 as in the first embodiment. The modified return springs 12 to 14 also operate in the same manner as the return spring 11B.

The return spring 11B of the third embodiment also includes the edge portions 124B, 125B, 211B to 216B, 145B, and 146B which are surfaces each extending in a plate thickness direction of the first extension part 101B, the second extension part 102B, and the contact part 103B. Then, the return spring 11B includes the cover part 104 that covers at least a part of the edge portions 124B, 211B, 213B, 215B, and 145B, and the cover part 105 that covers at least a part of the edge portions 125B, 212B, 214B, 216B, and 146B. Therefore, the cover part 104 can suppress exposure of the edge portions 124B, 211B, 213B, 215B, and 145B, and can suppress fingers getting caught on the edge portions 124B, 211B, 213B, 215B, and 145B. Also, the cover part 105 can suppress exposure of the edge portions 125B, 212B, 214B, 216B, and 146B, and can suppress fingers getting caught on the edge portions 125B, 212B, 214B, 216B, and 146B. Therefore, maintainability of a disc brake 1 in which the return spring 11B and the like are provided can be improved.

Also in the return spring 11B, the cover parts 104 and 105 are provided to extend from at least one of the first extension part 101B, the second extension part 102B, and the contact part 103B. Specifically, the cover parts 104 and 105 of the return spring 11B extend from the intermediate plate part 142 of the contact part 103B. Therefore, the cover parts 104 and 105 can be formed integrally with the fixing part 100, the first extension part 101B, the second extension part 102B, and the contact part 103B. Therefore, the return spring 11B can be manufactured easily and at a low cost, and an increase in man-hours for assembling them can also be suppressed.

Also in the return spring 11B, the cover parts 104 and 105 are provided to extend not from a curved portion that affects a spring load that occurs, but rather from the flat plate-shaped intermediate plate part 142 having little influence on a spring load that occurs. Therefore, the return spring 11B can also reduce an influence of forming the cover parts 104 and 105 on a spring load that occurs, that is, on a spring performance.

Also in the return spring 11B and the like of the third embodiment, only one of the cover parts 104 and 105 may be provided as in the first embodiment.

### Fourth Embodiment

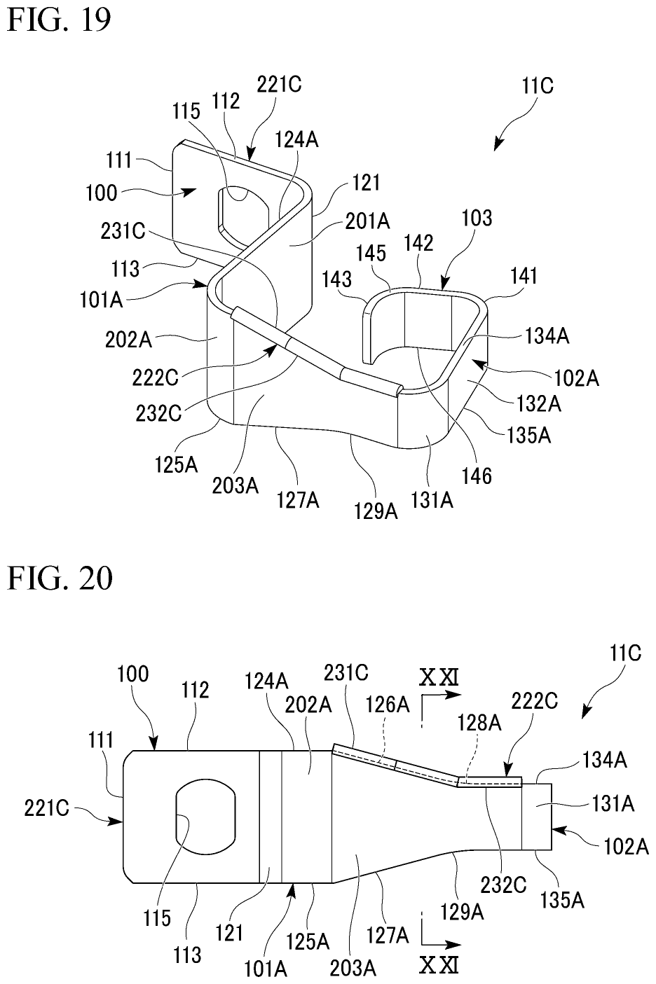

Next, a fourth embodiment will be described mainly on the basis of FIGS. 19 to 21, focusing on differences from the second embodiment. Further, parts common to those in the second embodiment will be denoted by the same terms and the same reference signs.

In the fourth embodiment, a return spring 11C is partially modified from the return spring 11A of the second embodiment. A return spring 13 is also modified in the same manner, and return springs 12 and 14 are also modified in substantially the same manner.

As illustrated in FIG. 19, the return spring 11C includes a return spring main body 221C having a structure in which the cover parts 104 and 105 of the return spring 11A of the second embodiment are eliminated. That is, the return spring main body 221C includes a fixing part 100, a first extension part 101A, a second extension part 102A, and a contact part 103, all of which are similar to those of the return spring 11A. On the other hand, the cover parts 104 and 105 are not provided on the return spring main body 221C. Since the cover part 104 is not provided, an edge portion 145 of the contact part 103 extends throughout a direction in which the contact part 103 extends. Also in this case, the edge portion 145 is disposed on the same plane as an edge portion 134A. Since the cover part 105 is not provided, an edge portion 146 of the contact part 103 extends throughout a direction in which the contact part 103 extends. Also in this case, the edge portion 146 is disposed on the same plane as an edge portion 135A.

As illustrated in FIGS. 19 and 20, the return spring 11C includes a cover part 222C that covers at least a part of edge portions 124A, 126A, 128A, 134A, and 145 of the return spring main body 221C. Specifically, the cover part 222C is provided on a distal end side extension plate part 203A of the first extension part 101A, and covers the entire edge portion 126A and the entire edge portion 128A as illustrated in FIG. 20. Therefore, the cover part 222C extends in a length direction of the edge portions 126A and 128A. The cover part 222C is formed of an elastic member such as rubber. The cover part 222C is adhesively fixed to the return spring main body 221C. Specifically, the cover part 222C is adhered to the return spring main body 221C by vulcanization adhesion.

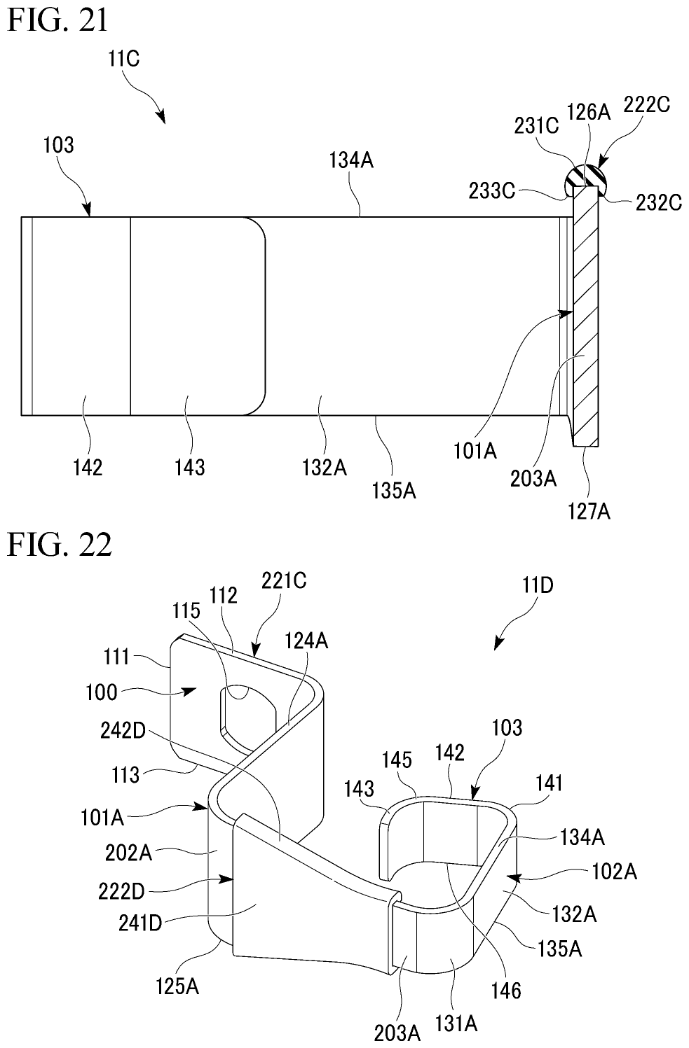

As illustrated in FIG. 21, the cover part 222C includes an edge cover part 231C, a protruding part 232C, and a protruding part 233C. In the cover part 222C, the edge cover part 231C, the protruding part 232C, and the protruding part 233C are seamlessly integrated. In other words, the cover part 222C is seamlessly and integrally formed in its entirety.

The edge cover part 231C has a semicircular cross section perpendicular to a length direction. Surfaces of the edge cover part 231C in contact with the edge portions 126A and 128A illustrated in FIG. 20 are adhered to the edge portions 126A and 128A and cover the edge portions 126A and 128A. As illustrated in FIG. 21, the edge cover part 231C has a length in a plate thickness direction of the distal end side extension plate part 203A that is longer than the plate thickness of the distal end side extension plate part 203A. The edge cover part 231C protrudes to both sides with respect to the distal end side extension plate part 203A in the plate thickness direction of the distal end side extension plate part 203A.

The protruding part 232C is provided on a side opposite to the contact part 103 from the distal end side extension plate part 203A in the plate thickness direction of the distal end side extension plate part 203A. The protruding part 232C protrudes from the edge cover part 231C to an edge portion 127A side.

The protruding part 233C is provided on the contact part 103 side from the distal end side extension plate part 203A in the plate thickness direction of the distal end side extension plate part 203A. The protruding part 233C protrudes from the edge cover part 231C to the edge portion 127A side. Also, surfaces of the protruding parts 232C and 233C in contact with the distal end side extension plate part 203A are adhered to the distal end side extension plate part 203A.

The return spring 11C is also attached to the lug part 72 of the outer friction pad 8 illustrated in FIGS. 4 to 6 at the return spring main body 221C similarly to the return spring 11A.

Then, with the return spring 11C attached, the friction pad 8 is supported by recessed parts 51 and 52 of a pair of outer wall parts 26 and 27 of a carrier 5 as in the second embodiment. Then, in the return spring main body 221C of the return spring 11C, the first extension part 101A, the second extension part 102A, and the contact part 103 are disposed in the same manner as those of the return spring 11A. Then, similarly to the return spring 11A, the return spring 11C brings the contact part 103 into contact with a surface portion 45 of the outer wall part 26 of the carrier 5.

In the return spring 11C, the edge portions 124A to 129A, 134A, 135A, 145, and 146 are surfaces facing in a disc radial direction. The cover part 222C of the return spring 11C covers the entire edge portion 126A and the entire edge portion 128A of the return spring main body 221C from a disc radially outer side.

In the return spring 11C, the return spring main body 221C thereof operates in the same manner as that in the return spring 11A.

The return spring 12 is modified to be a part having a mirror-symmetrical shape with the return spring 11C, and is attached to the friction pad 8 as in the second embodiment. The return spring 12 modified in this way has a configuration in which a cover part having a mirror-symmetrical shape with the cover part 222C covers the edge portions 127A and 129A of the return spring main body 221C. The return spring 12 modified in this way is configured such that the cover part having a mirror-symmetrical shape with the cover part 222C covers the return spring main body 221C from the disc radially outer side.

The return spring 13 is modified to be a common part having the same shape as the return spring 11C, and is attached to a friction pad 9 as in the second embodiment. The return spring 13 modified in this way is configured such that the cover part 222C covers the return spring main body 221C from the disc radially outer side.

The return spring 14 is modified to be a part having a mirror-symmetrical shape with the return spring 11C, and is attached to the friction pad 9 as in the second embodiment. The return spring 14 modified in this way has a configuration in which a cover part having a mirror-symmetrical shape with the cover part 222C covers the edge portions 127A and 129A of the return spring main body 221C. The return spring 14 modified in this way is configured such that the cover part having a mirror-symmetrical shape with the cover part 222C covers the return spring main body 221C from the disc radially outer side.

The return spring 11C of the fourth embodiment also includes the edge portions 124A to 129A, 134A, 135A, 145, and 146 which are surfaces each extending in a plate thickness direction of the first extension part 101A, the second extension part 102A, and the contact part 103. Then, the return spring 11C includes the cover part 222C that covers at least a part of the edge portions 124A to 129A, 134A, 135A, 145, and 146. Specifically, the return spring 11C includes the cover part 222C that covers the edge portions 126A and 128A which are at least a part of the edge portions 124A, 126A, 128A, 134A, and 145. Therefore, the cover part 222C can suppress exposure of the edge portions 124A, 126A, 128A, 134A, and 145, and can suppress fingers getting caught on the edge portions 124A, 126A, 128A, 134A, and 145.

Also, since the cover part 222C of the return spring 11C is formed of an elastic member, the cover part 222C can be easily provided at an appropriate portion of the edge portions 124A to 129A, 134A, 135A, 145, and 146.

Here, in the return spring 11C of the fourth embodiment, a case in which the cover part 222C that covers at least a part of the edge portions 124A, 126A, 128A, 134A, and 145 is provided has been described as an example, but the present invention is not limited thereto. For example, in addition to the cover part 222C or in place of the cover part 222C, a cover part similar to the cover part 222C may be provided to cover at least a part of the edge portions 125A, 127A, 129A, 135A, and 146. In that case, similar modifications are also made to the return springs 12 to 14.

Also, in the return spring 11C of the fourth embodiment, a case in which the return spring 11A of the second embodiment without the cover parts 104 and 105 is used as the return spring main body 221C, and the cover part 222C formed of an elastic member is provided on at least a part of the edge portions 124A to 129A, 134A, 135A, 145, and 146 of the return spring main body 221C has been described as an example. However, the present invention is not limited thereto. For example, the return spring 11 of the first embodiment without the cover parts 104 and 105 can be used as a return spring main body, and a cover part similar to the cover part 222C can be provided to cover at least a part of the edge portions 124 to 127, 134, 135, 145, and 146 of the above-described return spring main body. Also, for example, the return spring 11B of the third embodiment without the cover parts 104 and 105 can be used as a return spring main body, and a cover part similar to the cover portion 222C can be provided to cover at least a part of the edge portions 124B, 125B, 211B to 216B, 145B, and 146B of the above-described return spring main body.

### Fifth Embodiment

Next, a fifth embodiment will be described mainly on the basis of FIGS. 22 to 24, focusing on differences from the fourth embodiment. Further, parts common to those in the fourth embodiment will be denoted by the same terms and the same reference signs.

In the fifth embodiment, a return spring 11D is partially modified from the return spring 11C of the fourth embodiment. Return springs 12 to 14 are modified in the same manner.

As illustrated in FIG. 22, the return spring 11D has a cover part 222D that is different from the cover part 222C instead of the cover part 222C.

The cover part 222D is formed of an elastic member such as rubber. The cover part 222D is a separate member from a return spring main body 221C. The cover part 222D is detachably attached to the return spring main body 221C. The cover part 222D is fitted and fixed to the return spring main body 221C. The cover part 222D may be fixed to the return spring main body 221C with an adhesive so that it is difficult to be detached.

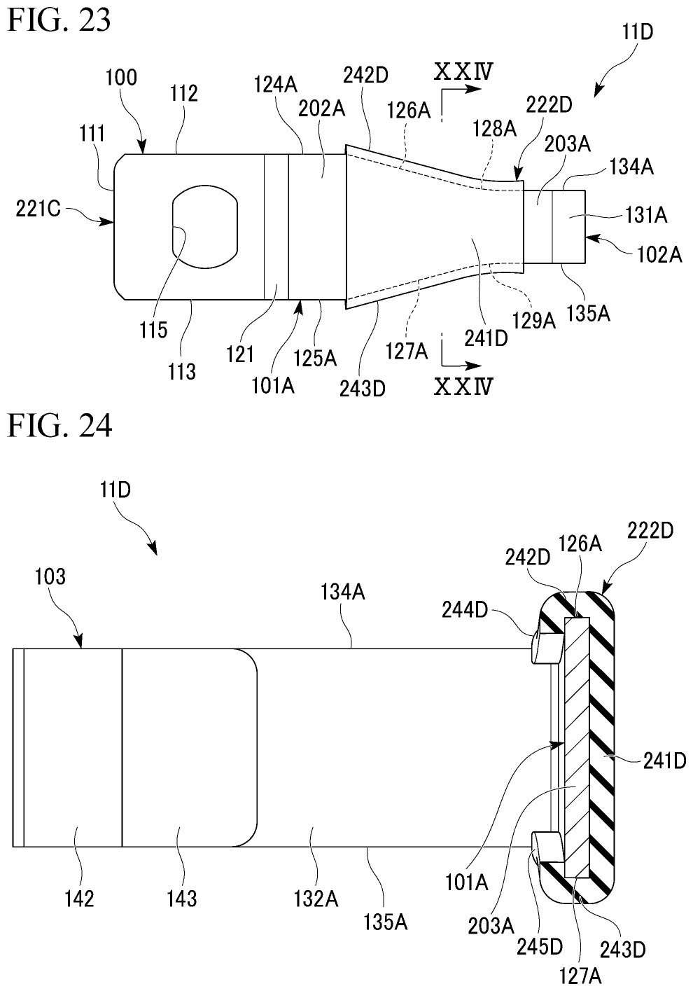

The cover part 222D covers at least a part of edge portions 124A to 129A, 134A, 135A, 145, and 146 of the return spring main body 221C. Specifically, the cover part 222D is provided on a distal end side extension plate part 203A of a first extension part 101A, and covers the entire edge portion 126A, the entire edge portion 127A, a part of the edge portion 128A on the edge portion 126A side, and a part of the edge portion 129A on the edge portion 127A side as illustrated in FIG. 23.

As illustrated in FIG. 24, the cover part 222D includes an intermediate cover part 241D, an edge cover part 242D, an edge cover part 243D, a locking part 244D, and a locking part 245D. In the cover part 222D, the intermediate cover part 241D, the edge cover part 242D, the edge cover part 243D, the locking part 244D, and the locking part 245D are seamlessly integrated. In other words, the entire cover part 222D is seamlessly and integrally formed in its entirety.

The intermediate cover part 241D covers a side opposite to a contact part 103 in a plate thickness direction of the distal end side extension plate part 203A.

The edge cover part 242D extends from an end edge portion of the intermediate cover part 241D on the edge portion 126A side to cover the edge portions 126A and 128A illustrated in FIG. 23, and is in contact with the edge portions 126A and 128A.

As illustrated in FIG. 24, the edge cover part 243D extends from an end edge portion of the intermediate cover part 241D on the edge portion 127A side to cover the edge portions 127A and 129A as illustrated in FIG. 23, and is in contact with the edge portions 127A and 129A.

As illustrated in FIG. 24, the locking part 244D protrudes in a direction of the edge portion 127A from an end edge portion of the edge cover part 242D on a side opposite to the intermediate cover part 241D. The locking part 244D is in contact with the distal end side extension plate part 203A on the contact part 103 side in the plate thickness direction. Thereby, the intermediate cover part 241D and the locking part 244D sandwich an end edge portion of the distal end side extension plate part 203A on the edge portions 126A and 128A side illustrated in FIG. 23.

As illustrated in FIG. 24, the locking part 245D protrudes in a direction of the edge portion 126A from an end edge portion of the edge cover part 243D on a side opposite to the intermediate cover part 241D. The locking part 245D is in contact with the distal end side extension plate part 203A on the contact part 103 side in the plate thickness direction. Thereby, the intermediate cover part 241D and the locking part 245D sandwich an end edge portion of the distal end side extension plate part 203A on the edge portions 127A and 129A side illustrated in FIG. 23.

The return spring 11D is also attached to the lug part 72 of the outer friction pad 8 illustrated in FIGS. 4 to 6 at the return spring main body 221C similarly to the return spring main body 221C of the return spring 11C.

Then, with the return spring 11D attached, the friction pad 8 is supported by recessed parts 51 and 52 of a pair of outer wall parts 26 and 27 of a carrier 5 as in the third embodiment. Then, the return spring main body 221C of the return spring 11D is configured such that the first extension part 101A, a second extension part 102A, and the contact part 103 are disposed similarly to those of the return spring main body 221C of the return spring 11C, that is, those of the return spring 11A. Then, the return spring 11D also brings a contact plate part 141 of the contact part 103 into contact with a surface portion 45 of the outer wall part 26 of the carrier 5.

In this state, the return spring 11D is configured such that the cover part 222D covers the entire edge portion 126A and a part of the edge portion 128A on the edge portion 126A side from a disc radially outer side. Also, in this state, the return spring 11D is configured such that the cover part 222D covers the entire edge portion 127A and a part of the edge portion 129A on the edge portion 127A side from a disc radially inner side.

Also in the return spring 11D, the return spring main body 221C thereof operates in the same manner as that in the return spring 11A.

The return springs 12 to 14 are also modified to be common parts having the same shape as the return spring 11D, and are attached to the friction pads 8 and 9 in the same manner as in the fourth embodiment.

The return spring 11D of the fifth embodiment also includes the cover part 222D which covers at least a part of the edge portions 124A to 129A, 134A, 135A, 145, and 146, specifically, the edge portions 126A to 129A. Therefore, the cover part 222D can suppress exposure of the edge portions 124A to 129A, 134A, 135A, 145, and 146, and can suppress fingers getting caught on the edge portions 124A to 129A, 134A, 135A, 145, and 146.

Also, since the cover part 222D of the return spring 11D is formed of an elastic member, the cover part 222C can be easily provided at an appropriate portion of the edge portions 124A to 129A, 134A, 135A, 145, and 146.

Also, in the return spring 11D, since the cover part 222D is formed of a separate member from the return spring main body 221C having the first extension part 101A, the second extension part 102A, and the contact part 103, for example, when the cover part 222C deteriorates, only the cover part 222C can be easily replaced.

Here, the return spring 11D of the fifth embodiment can also be modified in the same manner as the return spring 11C of the fourth embodiment. That is, the return spring 11 of the first embodiment without the cover parts 104 and 105 can be used as a return spring main body, and a cover part similar to the cover part 222D can be provided to cover at least a part of the edge portions 124 to 127, 134, 135, 145, and 146 of the above-described return spring main body. Also, for example, the return spring 11B of the third embodiment without the cover parts 104 and 105 can be used as a return spring main body, and a cover part similar to the cover portion 222D can be provided to cover at least a part of the edge portions 124B, 125B, 211B to 216B, 145B, and 146B of the above-described return spring main body.

### Sixth Embodiment

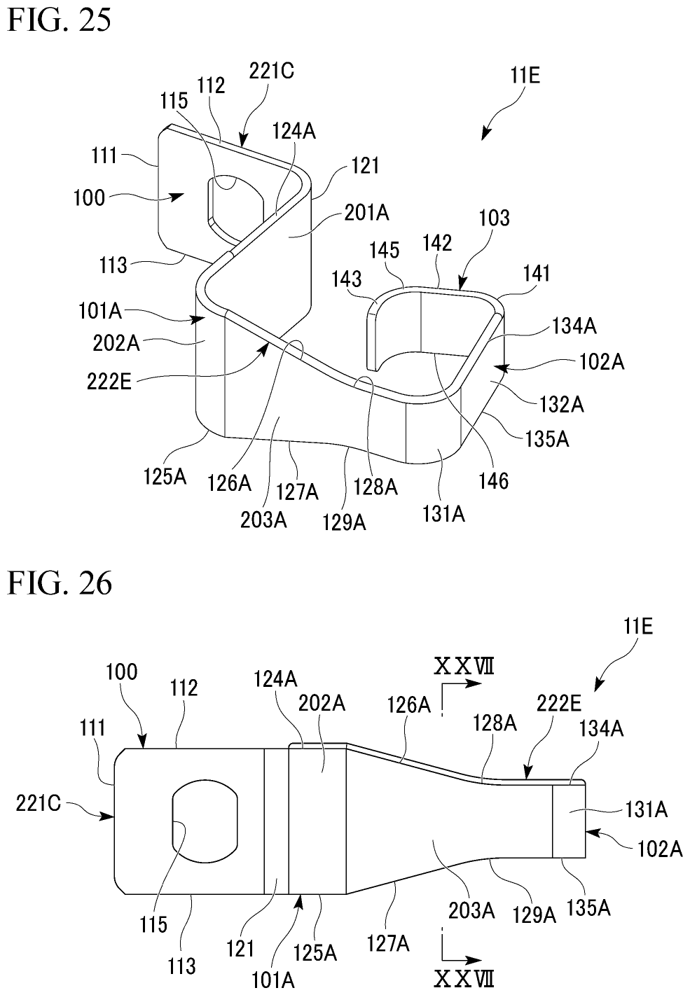

Next, a sixth embodiment will be described mainly on the basis of FIGS. 25 to 27, focusing on differences from the fourth embodiment. Further, parts common to those in the fourth embodiment will be denoted by the same terms and the same reference signs.

In the sixth embodiment, a return spring 11E is partially modified from the return spring 11C of the fourth embodiment. A return spring 13 is also modified in the same manner, and return springs 12 and 14 are also modified in substantially the same manner.

As illustrated in FIGS. 25 to 27, the return spring 11E includes a cover part 222E that is different from the cover part 222C instead of the cover part 222C. As illustrated in FIG. 25, the cover part 222E covers at least a part of edge portions 124A to 129A, 134A, 135A, 145, and 146 of a return spring main body 221C. Specifically, the cover part 222E is provided on a first extension part 101A and a second extension part 102A, and covers a part of the edge portion 124A on the edge portion 126A side, the entire edge portion 126A, the entire edge portion 128A, and the entire edge portion 134A.

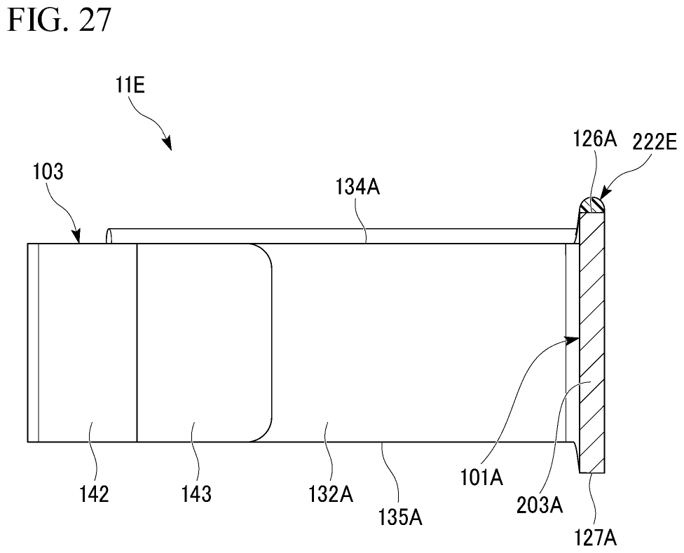

The cover part 222E extends in a direction in which the edge portions 124A, 126A, 128A, and 134A extend. The cover part 222E is formed of a resin member. The cover part 222E becomes fixed to the return spring main body 221C by, for example, being applied and cured. As illustrated in FIG. 27, the cover part 222E has a semicircular cross section perpendicular to a length direction. As illustrated in FIG. 25, surfaces of the cover part 222E in contact with the edge portions 124A, 126A, 128A, and 134A are fixed to the edge portions 124A, 126A, 128A, and 134A. The cover part 222E is provided on the edge portions 124A, 126A, 128A, and 134A, and covers the edge portions 124A, 126A, 128A, and 134A.

The return spring 11E is also attached to the lug part 72 of the outer friction pad 8 illustrated in FIGS. 4 to 6 at the return spring main body 221C similarly to the return spring main body 221C of the return spring 11C.

Then, with the return spring 11E attached, the friction pad 8 is supported by recessed parts 51 and 52 of a pair of outer wall parts 26 and 27 of a carrier 5 as in the fourth embodiment. Then, the return spring main body 221C of the return spring 11E is configured such that the first extension part 101A, the second extension part 102A, and a contact part 103 are disposed similarly to those of the return spring main body 221C of the return spring 11C, that is, those of the return spring 11A. Then, the return spring 11E also brings a contact plate part 141 of the contact part 103 into contact with a surface portion 45 of the outer wall part 26 of the carrier 5.

Also in the return spring 11E, the return spring main body 221C operates in the same manner as that in the return spring 11A.

The return spring 12 is modified to be a part having a mirror-symmetrical shape with the return spring 11E, and is attached to the friction pad 8 as in the fourth embodiment. The return spring 12 modified in this way has a configuration in which a cover part having a mirror-symmetrical shape with the cover part 222E covers the edge portions 124A, 127A, 129A, and 135A of the return spring main body 221C. The return spring 12 modified in this way is configured such that the cover part having a mirror-symmetrical shape with the cover part 222E covers the return spring main body 221C from a disc radially outer side.

The return spring 13 is modified to be a common part having the same shape as the return spring 11E, and is attached to a friction pad 9 as in the fourth embodiment. The return spring 13 modified in this way is configured such that the cover part that is similar to the cover part 222E covers the return spring main body 221C from the disc radially outer side.

The return spring 14 is modified to be a part having a mirror-symmetrical shape with the return spring 11E, and is attached to the friction pad 9 as in the fourth embodiment. The return spring 14 modified in this way has a configuration in which a cover part having a mirror-symmetrical shape with the cover part 222E covers the edge portions 124A, 127A, 129A, and 135A of the return spring main body 221C. The return spring 14 modified in this way is configured such that the cover part having a mirror-symmetrical shape with the cover part 222E covers the return spring main body 221C from the disc radially outer side.

The return spring 11E of the sixth embodiment also includes the cover part 222E which covers at least a part of the edge portions 124A to 129A, 134A, 135A, 145, and 146 of the return spring main body 221C. Specifically, the return spring 11E includes the cover part 222E that covers the edge portions 124A, 126A, 128A, and 134A which are at least a part of the edge portions 124A, 126A, 128A, 134A, and 145. Therefore, the cover part 222E can suppress exposure of the edge portions 124A, 126A, 128A, 134A, and 145, and can suppress fingers getting caught on the edge portions 124A, 126A, 128A, 134A, and 145.

Also, since the cover part 222E of the return spring 11E is formed of a resin, the cover part 222E can be easily provided at an appropriate portion of the edge portions 124A to 129A, 134A, 135A, 145, and 146.

Here, in the return spring 11E of the sixth embodiment, a case in which the cover part 222E that covers at least a part of the edge portions 124A, 126A, 128A, 134A, and 145 is provided has been described as an example, but the present invention is not limited thereto. For example, in addition to the cover part 222E or in place of the cover part 222E, a cover part similar to the cover part 222E may be provided to cover at least a part of the edge portions 125A, 127A, 129A, 135A, and 146. In that case, similar modifications are also made to the return springs 12 to 14.

Also, the return spring 11E of the sixth embodiment can also be modified in the same manner as the return spring 11C of the fourth embodiment. That is, the return spring 11 of the first embodiment without the cover parts 104 and 105 can be used as a return spring main body, and a cover part similar to the cover part 222E can be provided to cover at least a part of the edge portions 124 to 127, 134, 135, 145, and 146 of the above-described return spring main body. Also, for example, the return spring 11B of the third embodiment without the cover parts 104 and 105 can be used as a return spring main body, and a cover part similar to the cover portion 222E can be provided to cover at least a part of the edge portions 124B, 125B, 211B to 216B, 145B, and 146B of the above-described return spring main body.

### Seventh Embodiment

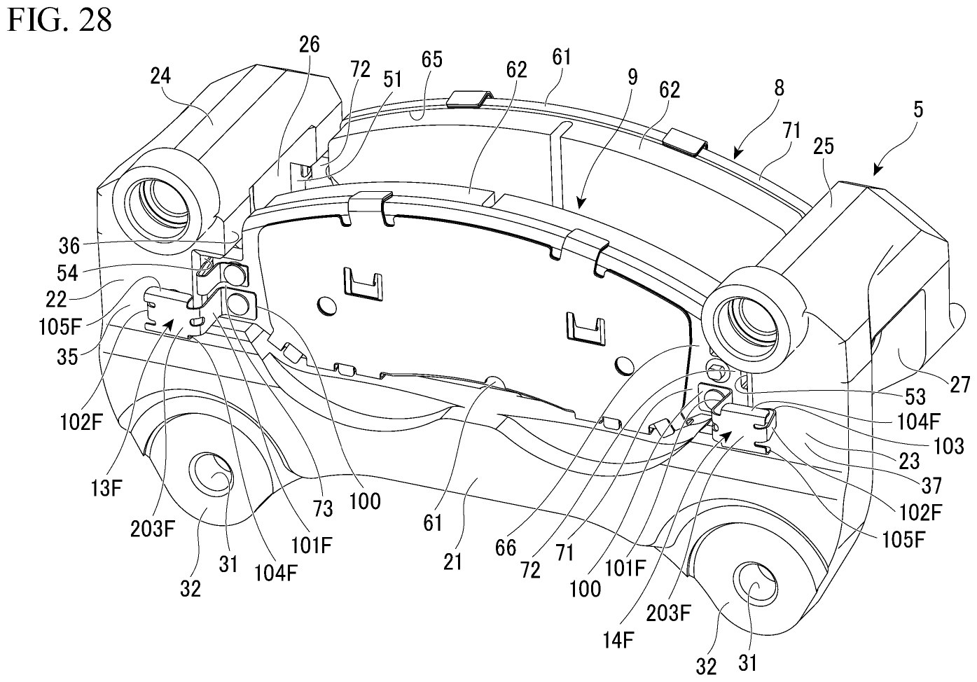

Next, a seventh embodiment will be described mainly on the basis of FIGS. 28 to 35, focusing on differences from the first embodiment. Further, parts common to those in the first embodiment will be denoted by the same terms and the same reference signs.

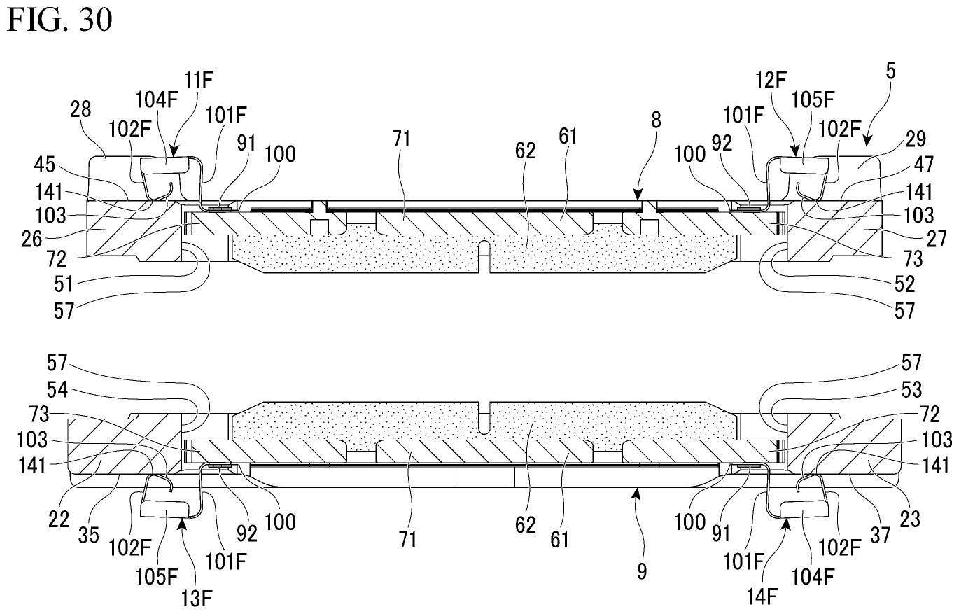

In the seventh embodiment, as illustrated in FIGS. 28 to 30, a return spring 13F, which is partially modified from the return spring 13 of the first embodiment, is provided instead of the return spring 13, and a return spring 14F, which is partially modified from the return spring 14, is provided instead of the return spring 14. In the seventh embodiment, as illustrated in FIG. 30, a return spring 11F, which is partially modified from the return spring 11, is provided instead of the return spring 11, and a return spring 12F, which is partially modified from the return spring 12, is provided instead of the return spring 12. The return springs 11F to 14F are also common parts having the same shape. Therefore, here, description will be made by taking the return spring 13F attached to a disc rotation direction first side of an inner friction pad 9 as an example.

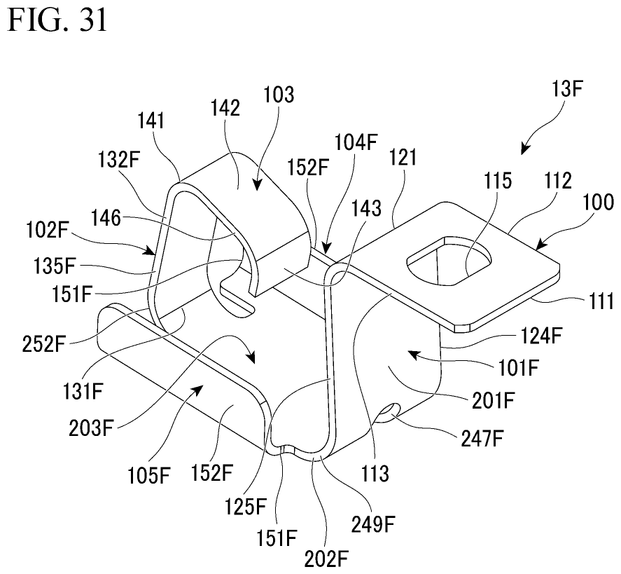

As illustrated in FIGS. 31 to 35, the return spring 13F has a mirror-symmetrical shape. As illustrated in FIGS. 31 to 35, the return spring 13F includes a first extension part 101F modified from the first extension part 101, a second extension part 102F modified from the second extension part 102, and a connection part 203F connecting the first extension part 101F and the second extension part 102F. The return spring 13F includes a cover part 104F illustrated in FIGS. 31, 32, and 34 provided instead of the cover part 104, and a cover part 105F illustrated in FIGS. 31 to 33 provided instead of the cover part 105.

The first extension part 101F has a plate shape and extends from a fixing part 100 to one side in a plate thickness direction of the fixing part 100. The first extension part 101F has a substantially constant plate thickness and is partially curved in the plate thickness direction. The first extension part 101F includes a protruding plate part 121 similar to that of the first embodiment, a base end side extension plate part 201F, and a first curved part 202F.

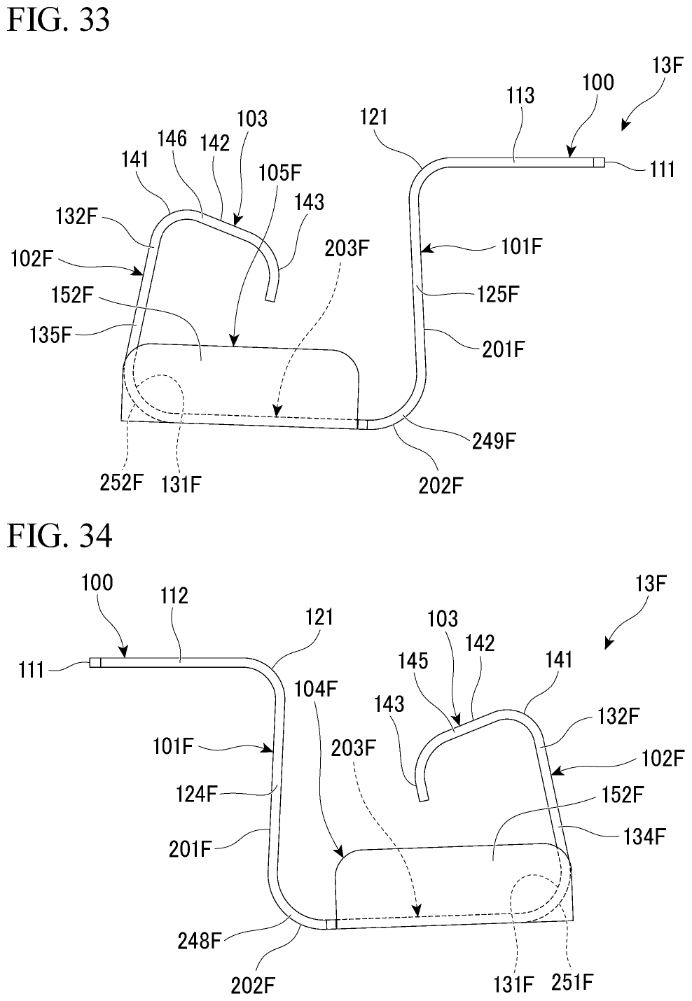

The base end side extension plate part 201F has a flat plate shape, and extends from an end portion of the protruding plate part 121 on a side opposite to the fixing part 100 to a side opposite to the fixing part 100 in the plate thickness direction of the fixing part 100. As illustrated in FIGS. 33 and 34, the base end side extension plate part 201F forms an acute angle of less than 90 degrees with the fixing part 100.

The first curved part 202F has a curved plate shape that is curved in an arcuate shape in a plate thickness direction thereof. The first curved part 202F protrudes from an end portion of the base end side extension plate part 201F on a side opposite to the protruding plate part 121 to a side opposite to an edge portion 111 in a direction in which edge portions 112 and 113 extend. The first curved part 202F is curved such that a center of curvature thereof is positioned on the fixing part 100 side in the plate thickness direction of the fixing part 100 with respect to the first curved part 202F.

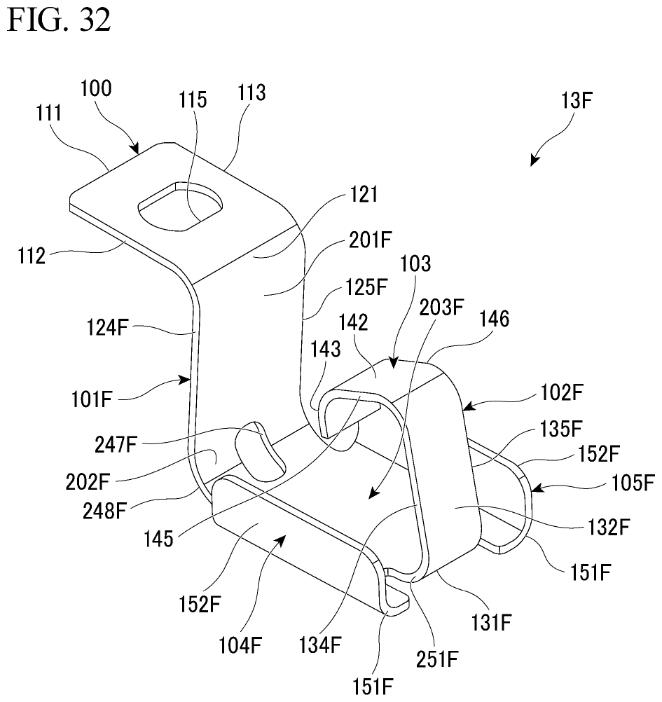

As illustrated in FIGS. 31 and 32, the first extension part 101F has an edge portion 124F and an edge portion 125F. Both the edge portions 124F and 125F are surfaces extending in a plate thickness direction of the first extension part 101F.

As illustrated in FIG. 32, the edge portion 124F is formed on the protruding plate part 121, the base end side extension plate part 201F, and the first curved part 202F. The edge portion 124F extends from an end edge portion on a side opposite to the edge portion 111 in a direction in which the edge portion 112 extends. The edge portion 124F is planar and disposed on the same plane as the edge portion 112.

As illustrated in FIG. 31, the edge portion 125F is formed on the protruding plate part 121, the base end side extension plate part 201F, and the first curved part 202F. The edge portion 125F extends from an end edge portion on a side opposite to the edge portion 111 in a direction in which the edge portion 113 extends. The edge portion 125F is planar and disposed on the same plane as the edge portion 113. Therefore, the edge portion 125F faces in a direction opposite to the edge portion 124F and is parallel to the edge portion 124F.

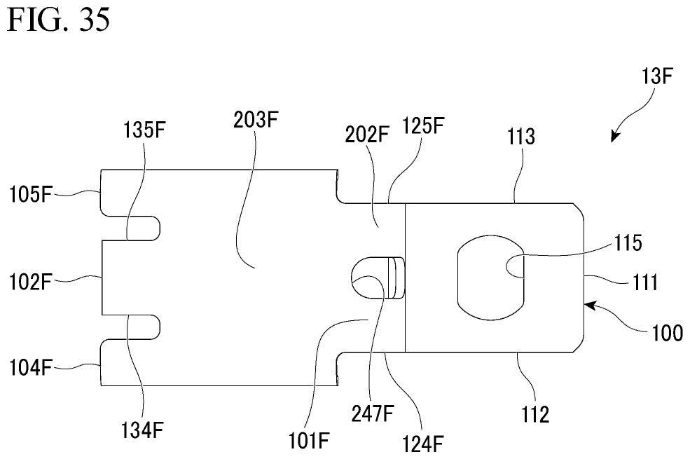

As illustrated in FIGS. 32 and 35, the first curved part 202F has a through hole 247F formed to penetrate the first curved part 202F in a thickness direction at a central position between the edge portions 124F and 125F.

As illustrated in FIGS. 33 and 34, the connection part 203F has a flat plate shape, and extends from an end portion of the first curved part 202F on a side opposite to the base end side extension plate part 201F in a direction opposite to the edge portion 111 in a direction in which the edge portions 112 and 113 extend. The connection part 203F extends in a direction of the fixing part 100. The connection part 203F forms an acute angle of less than 90 degrees with the base end side extension plate part 201F.

The second extension part 102F has a plate shape and extends from an end portion of the connection part 203F on a side opposite to the first curved part 202F to just short of the fixing part 100 in the plate thickness direction of the fixing part 100. The second extension part 102F has a substantially constant plate thickness and is partially curved in the plate thickness direction. The second extension part 102F includes a second curved part 131F and an intermediate extension plate part 132F.

The second curved part 131F protrudes from an end portion of the connection part 203F on a side opposite to the first curved part 202F to the fixing part 100 side in the plate thickness direction of the fixing part 100. The second curved part 131F has a curved plate shape that is curved in an arcuate shape in a plate thickness direction thereof. The second curved part 131F is curved such that a center of curvature thereof is positioned on the edge portion 111 side in a direction in which the edge portions 112 and 113 extend with respect to the second curved part 131F.

The intermediate extension plate part 132F has a flat plate shape and extends from an end portion of the second curved part 131F on a side opposite to the connection part 203F. The intermediate extension plate part 132F extends to approach the fixing part 100 in the plate thickness direction of the fixing part 100 from the second curved part 131F. The intermediate extension plate part 132F approaches the edge portion 111 in a direction in which the edge portions 112 and 113 extend toward an extension distal end side. The intermediate extension plate part 132F forms an acute angle of less than 90 degrees with the connection part 203F.

As described above, in the return spring 13F, the connection part 203F connects the first extension part 101F and the second extension part 102F in a direction different from directions of the first extension part 101F and the second extension part 102F. Also, the return spring 13F includes the first curved part 202F provided in the first extension part 101F and connected to the connection part 203F, and a second curved part 131F provided in the second extension part 102F and connected to the connection part 203F. In the return spring 13F, only one of the first curved part 202F and the second curved part 131F may be provided. As illustrated in FIGS. 31 and 32, the return spring 13F includes the cover parts 104F and 105F provided to extend from the connection part 203F.

The second extension part 102F has an edge portion 134F illustrated in FIG. 32 and an edge portion 135F illustrated in FIG. 31. The edge portions 134F and 135F are both formed on the second curved part 131F and the intermediate extension plate part 132F. Both the edge portions 134F and 135F are surfaces extending in a plate thickness direction of the second extension part 102F. As illustrated in FIG. 35, a distance between the edge portions 134F and 135F of the second extension part 102F is smaller than a distance between the edge portions 124F and 125F of the first extension part 101F.

As illustrated in FIGS. 33 and 34, a contact part 103 has the same shape as that in the first embodiment. The contact part 103 extends from an end portion of the intermediate extension plate part 132F on a side opposite to the second curved part 131F toward the edge portion 111 to just short of the first extension part 101F in the direction in which the edge portions 112 and 113 extend. The contact part 103 is disposed on the same side as the first extension part 101F and the second extension part 102F with respect to the fixing part 100 in the plate thickness direction of the fixing part 100.

In the contact part 103, a contact plate part 141 protrudes from an end portion of the intermediate extension plate part 132F on a side opposite to the second curved part 131F toward the edge portion 111 in a direction in which the edge portions 112 and 113 extend. The contact plate part 141 is curved such that a center of curvature thereof is positioned on a side opposite to the fixing part 100 in the plate thickness direction of the fixing part 100 with respect to the contact plate part 141.

An intermediate plate part 142 approaches the edge portion 111 in a direction in which the edge portions 112 and 113 extend from an end portion of the contact plate part 141 on a side opposite to the intermediate extension plate part 132F, and then extends in a direction away from the fixing part 100 in the plate thickness direction of the fixing part 100. The intermediate plate part 142 forms an acute angle of less than 90 degrees with the intermediate extension plate part 132F.

An inwardly extending plate part 143 extends from an end portion of the intermediate plate part 142 on a side opposite to the contact plate part 141 to a side opposite to the fixing part 100 in the plate thickness direction of the fixing part 100. The inwardly extending plate part 143 is curved such that a center of curvature thereof is positioned on a side opposite to the edge portion 111 in a direction in which the edge portions 112 and 113 extend with respect to the inwardly extending plate part 143.

In the contact part 103, an edge portion 145 illustrated in FIG. 32 extends from an end edge portion of the edge portion 134F on a side opposite to the cover part 104F. The edge portion 145 is disposed on the same plane as the edge portion 134F. In the contact part 103, an edge portion 146 illustrated in FIG. 31 extends from an end edge portion of the edge portion 135F on a side opposite to the cover part 105F. The edge portion 146 is disposed on the same plane as the edge portion 135F.

In each of the fixing part 100, the first extension part 101F, the connection part 203F, the second extension part 102F, and the contact part 103, a line in the plate thickness direction passes through one plane. The edge portions 112, 113, 124F, 125F, 134F, 135F, 145, and 146 are parallel to the planes, respectively.

As illustrated in FIG. 32, the cover part 104F extends from between the edge portion 124F and the edge portion 134F. As illustrated in FIG. 31, the cover part 105F extends from between the edge portion 125F and the edge portion 135F. The pair of cover parts 104F and 105F have a mirror-symmetrical shape. Both the cover parts 104F and 105F have a substantially constant plate thickness and are partially curved in the plate thickness direction. The cover parts 104F and 105F each include a base end plate part 151F and a cover plate part 152F.

As illustrated in FIG. 32, the base end plate part 151F of the cover part 104F protrudes from between the edge portion 124F and the edge portion 134F. The base end plate part 151F of the cover part 104F curves to the contact part 103 side in a plate thickness direction of the connection part 203F while protruding in a direction perpendicular to the edge portions 124F and 134F which are surfaces.

The cover plate part 152F of the cover part 104F has a flat plate shape. The cover plate part 152F of the cover part 104F extends from an end portion of the base end plate part 151F of the cover part 104F on a side opposite to the connection part 203F in a direction toward the contact part 103 in the plate thickness direction of the connection part 203F. The cover plate part 152F of the cover part 104F extends parallel to the edge portions 124F and 134F, which are surfaces, with a predetermined distance therebetween.

The cover part 104F covers at least a part of the edge portions 124F, 134F, and 145. The cover part 104F is provided at a position overlapping at least a part of the first curved part 202F and the second curved part 131F in the plate thickness direction.

Specifically, the cover part 104F is provided at a position overlapping the second curved part 131F in a plate thickness direction of the second curved part 131F as illustrated in FIG. 34 at a predetermined distance from the second curved part 131F in a direction perpendicular to the edge portion 134F, which is a surface, as illustrated in FIG. 32. In other words, the cover part 104F overlaps the second curved part 131F of the second extension part 102F in position in a direction in which the edge portion 134F, which is a surface, extends. In yet other words, the cover part 104F faces an edge forming part 251F of the edge portion 134F formed at the second curved part 131F in a direction perpendicular to the edge portion 134F, which is a surface, and covers the edge forming part 251F at a position separated by a predetermined distance. The cover part 104F overlaps the entire edge forming part 251F in position in the plate thickness direction of the second curved part 131F.

Here, the cover part 104F may be provided to cover an edge forming part 248F at a position overlapping the first curved part 202F in a plate thickness direction of the first curved part 202F at a predetermined distance from the edge forming part 248F in a direction perpendicular to the edge forming part 248F of the edge portion 124F provided at the first curved part 202F. Also, the cover part 104F may be provided to cover the edge forming parts 248F and 251F with respect to both the first curved part 202F and the second curved part 131F at a position overlapping the first curved part 202F in the plate thickness direction of the first curved part 202F and overlapping the second curved part 131F in the plate thickness direction of the second curved part 131F at a predetermined distance from the edge forming parts 248F and 251F in a direction perpendicular to the edge forming parts 248F and 251F.

As illustrated in FIG. 31, the base end plate part 151F of the cover part 105F protrudes from between the edge portion 125F and the edge portion 135F. The base end plate part 151F of the cover part 105F curves to the contact part 103 side in the plate thickness direction of the connection part 203F while protruding in a direction perpendicular to the edge portions 125F and 135F which are surfaces.

The cover plate part 152F of the cover part 105F has a flat plate shape. The cover plate part 152F of the cover part 105F extends from an end portion of the base end plate part 151F of the cover part 105F on a side opposite to the connection part 203F in a direction toward the contact part 103 in the plate thickness direction of the connection part 203F. The cover plate part 152F of the cover part 105F extends parallel to the edge portions 125F and 135F, which are surfaces, with a predetermined distance therebetween. Therefore, the cover plate parts 152F of the cover parts 104F and 105F extend parallel to each other.

The cover part 105F covers at least a part of the edge portions 125F, 135F, and 146. The cover part 105F is provided at a position overlapping at least a part of the first curved part 202F and the second curved part 131F in the plate thickness direction.

Specifically, the cover part 105F is provided at a position overlapping the second curved part 131F in the plate thickness direction of the second curved part 131F as illustrated in FIG. 33 at a predetermined distance from the second curved part 131F in a direction perpendicular to the edge portion 135F, which is a surface, as illustrated in FIG. 31. In other words, the cover part 105F overlaps the second curved part 131F of the second extension part 102F in position in a direction in which the edge portion 135F, which is a surface, extends. In yet other words, the cover part 105F faces an edge forming part 252F of the edge portion 135F formed at the second curved part 131F in a direction perpendicular to the edge portion 135F, which is a surface, and covers the edge forming part 252F at a position separated by a predetermined distance. The cover part 105F overlaps the entire edge forming part 252F in position in the plate thickness direction of the second curved part 131F.

Here, the cover part 105F may be provided to cover an edge forming part 249F at a position overlapping the first curved part 202F in the plate thickness direction of the first curved part 202F at a predetermined distance from the edge forming part 249F in a direction perpendicular to the edge forming part 249F of the edge portion 125F provided at the first curved part 202F. Also, the cover part 105F may be provided to cover the edge forming parts 249F and 252F with respect to both the first curved part 202F and the second curved part 131F at a position overlapping the first curved part 202F in the plate thickness direction of the first curved part 202F and overlapping the second curved part 131F in the plate thickness direction of the second curved part 131F at a predetermined distance from the edge forming parts 249F and 252F in a direction perpendicular to the edge forming parts 249F and 252F.

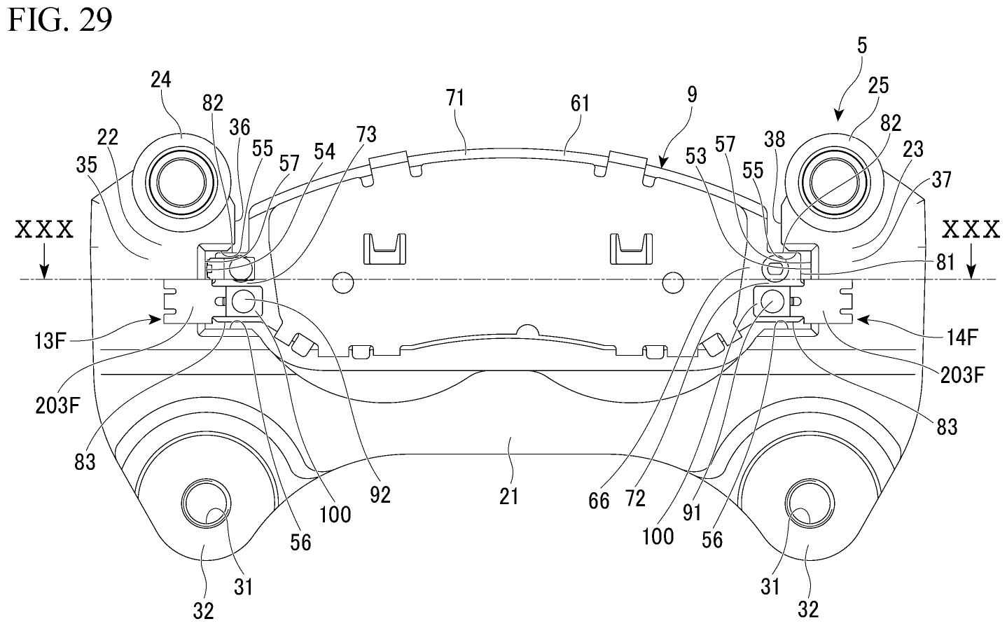

As illustrated in FIGS. 28 and 29, the return spring 13F is attached to a lug part 73 of the inner friction pad 9 in the same manner as the return spring 13. At that time, the return spring 13F is disposed such that the first extension part 101F, the connection part 203F, the second extension part 102F, and the cover parts 104F and 105F illustrated in FIG. 28, and the contact part 103 illustrated in FIG. 30 are positioned on a side opposite to a main plate part 71 with respect to the fixing part 100.

With the return spring 13F fixed to the friction pad 9, the connection part 203F, the second extension part 102F, and the cover parts 104F and 105F illustrated in FIG. 28, and the contact part 103 illustrated in FIG. 30 protrude to a side opposite to the main plate part 71 with respect to the lug part 73. In this state, in the return spring 13F, among the connection part 203F, the second extension part 102F, and the cover parts 104F and 105F illustrated in FIG. 28, and the contact part 103 illustrated in FIG. 30, the contact plate part 141 of the contact part 103 is positioned closest to a back plate 61 side in a plate thickness direction of the back plate 61 of the friction pad 9.

The return spring 14F is fixed to a lug part 72 of the inner friction pad 9 not to rotate in a state in which it is disposed in a mirror-symmetrical manner with the return spring 13F. At that time, the return spring 14F is disposed such that the first extension part 101F, the connection part 203F, the second extension part 102F, the contact part 103, and the cover parts 104F and 105F illustrated in FIG. 28 are positioned on a side opposite to a main plate part 71 with respect to the fixing part 100.

With the return spring 14F fixed to the friction pad 9, the connection part 203F, the second extension part 102F, the contact part 103, and the cover parts 104F and 105F protrude to a side opposite to the main plate part 71 with respect to the lug part 72. In this state, in the return spring 14F, among the connection part 203F, the second extension part 102F, the contact part 103, and the cover parts 104F and 105F, the contact plate part 141 of the contact portion 103 illustrated in FIG. 30 is positioned closest to the back plate 61 side in the plate thickness direction of the back plate 61 of the friction pad 9.

As illustrated in FIG. 30, the return spring 11F is fixed to the lug part 72 of an outer friction pad 8 not to rotate similarly to the return spring 14F. At that time, the return spring 11F is disposed such that the first extension part 101F, the connection part 203F, the second extension part 102F, the contact part 103, and the cover parts 104F and 105F are positioned on a side opposite to the main plate part 71 with respect to the fixing part 100.

With the return spring 11F fixed to the friction pad 8, the connection part 203F, the second extension part 102F, the contact part 103, and the cover parts 104F and 105F protrude to a side opposite to the main plate part 71 with respect to the lug part 72. In this state, in the return spring 11F, among the connection part 203F, the second extension part 102F, the contact part 103, and the cover parts 104F and 105F, the contact plate part 141 of the contact portion 103 is positioned closest to the back plate 61 side in the plate thickness direction of the back plate 61 of the friction pad 8.

The return spring 12F is fixed to the lug part 73 of the outer friction pad 8 not to rotate similarly to the return spring 13F. At that time, the return spring 12F is disposed such that the first extension part 101F, the connection part 203F, the second extension part 102F, the contact part 103, and the cover parts 104F and 105F are positioned on a side opposite to the main plate part 71 with respect to the fixing part 100.

With the return spring 12F fixed to the friction pad 8, the connection part 203F, the second extension part 102F, the contact part 103, and the cover parts 104F and 105F protrude to a side opposite to the main plate part 71 with respect to the lug part 73. In this state, in the return spring 12F, among the connection part 203F, the second extension part 102F, the contact part 103, and the cover parts 104F and 105F, the contact plate part 141 of the contact portion 103 is positioned closest to the back plate 61 side in the plate thickness direction of the back plate 61 of the friction pad 8.

As illustrated in FIG. 28, the inner friction pad 9 is supported by a recessed part 53 of an inner wall part 23 of a carrier 5 and a recessed part 54 of an inner wall part 22 forming a mirror-symmetrical shape with the recessed part 53 in a state in which the return springs 13F and 14F are attached thereto. Then, the pair of return springs 13F and 14F are both disposed on the inner side of the inner friction pad 9. Also, the return spring 13F, which is one of the return springs 13F and 14F, is disposed on the disc rotation direction first side. Also, the other return spring 14F of the return springs 13F and 14F is disposed on a disc rotation direction second side.

In the return spring 13F, the edge portions 124F, 125F, 134F, 135F, 145, and 146 illustrated in FIG. 31 or FIG. 32 face in a disc radial direction. In the return spring 13F, the cover part 104F covers the entire edge forming part 251F of the edge portion 134F on a disc rotation direction outward side from a disc radially inner side. Also, in the return spring 13F, the cover part 105F covers the entire edge forming part 252F of the edge portion 135F on the disc rotation direction outward side from a disc radially outer side.

As illustrated in FIG. 28, the first extension part 101F of the return spring 13F extends from the fixing part 100 in a direction away from the friction pad 9 in a plate thickness direction of the friction pad 9. Also, the connection part 203F of the return spring 13F extends from an inner end edge portion of the first extension part 101F to the disc rotation direction first side. Also, the second extension part 102F of the return spring 13F extends from an end edge portion of the connection part 203F on the disc rotation direction first side to the outer side in the plate thickness direction of the friction pad 9. That is, the second extension part 102F of the return spring 13F extends from the connection part 203F in a direction in which the friction pad 9 is pressed by a caliper 6 illustrated in FIG. 1.

In the return spring 13F, the connection part 203F, the second extension part 102F, the contact part 103, and the cover parts 104F and 105F overlap the inner wall part 22 in position in the disc rotation direction and the disc radial direction. As illustrated in FIG. 30, the contact part 103 of the return spring 13F extends from the second extension part 102F to come into contact with a surface portion 35 of the inner wall part 22 of the carrier 5 at the contact plate part 141. At that time, the contact part 103 of the return spring 13F extends from the second extension part 102F to the disc rotation direction second side.

As illustrated in FIG. 28, the first extension part 101F of the return spring 14F extends from the fixing part 100 in a direction away from the friction pad 9 in the plate thickness direction of the friction pad 9. Also, the connection part 203F of the return spring 14F extends from an inner end edge portion of the first extension part 101F to the disc rotation direction second side. Also, the second extension part 102F of the return spring 14F extends from an end edge portion of the connection part 203F on the disc rotation direction second side to the outer side in the plate thickness direction of the friction pad 9. That is, the second extension part 102F of the return spring 14F extends from the connection part 203F in a direction in which the friction pad 9 is pressed by the caliper 6 illustrated in FIG. 1.

In the return spring 14F, the connection part 203F, the second extension part 102F, the contact part 103, and the cover parts 104F and 105F overlap the inner wall part 23 in position in the disc rotation direction and the disc radial direction. The contact part 103 of the return spring 14F extends from the second extension part 102F to come into contact with a surface portion 37 of the inner wall part 23 of the carrier 5 at the contact plate part 141 as illustrated in FIG. 30. At that time, the contact part 103 of the return spring 14F extends from the second extension part 102F to the disc rotation direction first side.

Also to the outer friction pad 8 illustrated in FIG. 30, the return spring 11F is attached on the disc rotation direction first side and the return spring 12F is attached on the disc rotation direction second side in the same manner as the return springs 13F and 14F are attached to the friction pad 9 described above. Then, the return spring 11F comes into contact with a surface portion 45 of an outer wall part 26 of the carrier 5. The return spring 12F comes into contact with a surface portion 47 of an outer wall part 27 of the carrier 5.

The return spring 13F is restricted from moving to a disc 2 side when the contact plate part 141 of the contact part 103 thereof comes into contact with the surface portion of the inner wall part 22. Therefore, when the inner friction pad 9 moves to the disc 2 side with respect to the carrier 5 due to the pressure from the caliper 6, the return spring 13F, which has been in a standby state, mainly elastically deforms the first curved part 202F of the first extension part 101F and the second curved part 131F of the second extension part 102F to be in an elastically deformed state. Thereby, the return spring 13F separates the fixing part 100 fixed to the friction pad 9 and the contact part 103 whose movement with respect to the carrier 5 is restricted in a disc axial direction.

Also, when the pressure on the inner friction pad 9 due to the caliper 6 is released, the return spring 13F, which has been in an elastically deformed state, returns the elastic deformation of the first curved part 202F of the first extension part 101F and the second curved part 131F of the second extension part 102F, which have been mainly elastically deformed, back to a standby state. Then, the return spring 13F brings the fixing part 100 fixed to the friction pad 9 and the contact part 103 which is in contact with the carrier 5 closer to each other in the disc axial direction. Thereby, the inner friction pad 9 moves to a side opposite to the disc 2 with respect to the carrier 5 in the disc axial direction to separate a lining 62 thereof from the disc 2.

The return springs 11F, 12F, and 14F are also common parts having the same shape as the return spring 13F, and operate in the same manner as the return springs 11, 12, and 14.

If the return springs 11F to 14F having the same configuration are described using the return spring 13F as an example, the return spring 13F includes the edge portions 124F, 125F, 134F, 135F, 145, and 146 which are surfaces each extending in a plate thickness direction of the first extension part 101F, the connection part 203F, the second extension part 102F, and the contact part 103. Then, the return spring 13F includes the cover part 104F that covers at least a part of the edge portions 124F, 134F, and 145, specifically the edge portion 134F, and the cover part 105F that covers at least a part of the edge portions 125F, 135F, and 146, specifically the edge portion 135F. Therefore, in the return spring 13F, the cover part 104F can suppress exposure of the edge portions 124F, 134F, and 145, and can suppress fingers getting caught on the edge portions 124F, 134F, and 145. Also, in the return spring 13F, the cover part 105F can suppress exposure of the edge portions 125F, 135F, and 146, and can suppress fingers getting caught on the edge portions 125F, 135F, and 146. Therefore, maintainability of a disc brake 1 in which the return springs 11F to 14F are provided can be improved.

If the return springs 11F to 14F having the same configuration are described using the return spring 13F as an example, the cover part 104F covers the edge portion 134F on the disc rotation direction outward side, and the cover part 105F covers the edge portion 135F on the disc rotation direction outward side. Therefore, the return spring 13F can effectively suppress fingers getting caught on the edge portions 124F and 125F. Therefore, maintainability of the disc brake 1 in which the return springs 11F to 14F are provided can be effectively improved.

If the return springs 11F to 14F having the same configuration are described using the return spring 13F as an example, the cover parts 104F and 105F are provided to extend from at least one of the first extension part 101F, the connection part 203F, the second extension part 102F, and the contact part 103. In the return spring 13F, specifically, the cover parts 104F and 105F are provided to extend from the connection part 203F. Therefore, in the return spring 13F, the cover parts 104F and 105F can be integrally formed with the fixing part 100, the first extension part 101F, the connection part 203F, the second extension part 102F, and the contact part 103. Therefore, the return springs 11F to 14F can be manufactured easily and at a low cost, and an increase in man-hours for assembling them can also be suppressed.

If the return springs 11F to 14F having the same configuration are described using the return spring 13F as an example, the cover parts 104F and 105F are provided to extend not from a curved portion that affects a spring load that occurs, but rather from the flat plate-shaped connection part 203F having little influence on a spring load that occurs. Therefore, the return springs 11F to 14F can suppress an influence of forming the cover parts 104F and 105F on a spring load that occurs, that is, on a spring performance.

If the return springs 11F to 14F having the same configuration are described using the return spring 13F as an example, the cover parts 104F and 105F are provided to extend not from the contact part 103 on a distal end side but rather from the connection part 203F on a more intermediate side. Therefore, the return springs 11F to 14F improve a material yield and can reduce costs.

Also, if the return springs 11F to 14F having the same configuration are described using the return spring 13F as an example, the cover parts 104F and 105F are provided to extend from the connection part 203F. Therefore, in the return spring 13F, the cover parts 104F and 105F can be easily formed integrally with the fixing part 100, the first extension part 101F, the connection part 203F, the second extension part 102F, and the contact part 103. Therefore, the return springs 11F to 14F can be manufactured easily and at a low cost.

Also, if the return springs 11F to 14F having the same configuration are described using the return spring 13F as an example, the return spring 13F includes the connection part 203F that connects the first extension part 101F and the second extension part 102F in a direction different from directions of the first extension part 101F and the second extension part 102F. Therefore, in the return spring 13F, the fixing part 100, the first extension part 101F, the connection part 203F, the second extension part 102F, and the contact part 103 can be easily formed integrally. Therefore, the return springs 11F to 14F can be manufactured easily and at a low cost.

Also, if the return springs 11F to 14F having the same configuration are described using the return spring 13F as an example, the return spring 13F includes at least one, specifically both, of the first curved part 202F provided in the first extension part 101F and connected to the connection part 203F, and the second curved part 131F provided in the second extension part 102F and connected to the connection part 203F. Therefore, in the return spring 13F, the fixing part 100, the first extension part 101F, the connection part 203F, the second extension part 102F, and the contact part 103 can be easily formed integrally. Therefore, the return springs 11F to 14F can be manufactured easily and at a low cost.

Also, if the return springs 11F to 14F having the same configuration are described using the return spring 13F as an example, the cover parts 104F and 105F are provided at a position overlapping at least one of the first curved part 202F and the second curved part 131F, specifically the second curved part 131F, in the plate thickness direction. Therefore, in the return spring 13F, the cover parts 104F and 105F can suppress exposure of at least one of the first curved part 202F and the second curved part 131F, specifically the second curved part 131F on the disc rotation direction outward side, and can suppress fingers getting caught on the first curved part 202F and the second curved part 131F. Therefore, maintainability of the disc brake 1 in which the return springs 11F to 14F are provided can be improved.

Also, if the return springs 11F to 14F having the same configuration are described using the return spring 13F as an example, the cover part 104F is provided at a predetermined distance from the first curved part 202F or the second curved part 131F, specifically, from both the first curved part 202F and the second curved part 131F. Also, in the return spring 13F, the cover part 105F is provided at a predetermined distance from the first curved part 202F or the second curved part 131F, specifically, from both the first curved part 202F and the second curved part 131F. Therefore, in the return spring 13F, the cover parts 104F and 105F can be easily formed integrally with the fixing part 100, the first extension part 101F, the connection part 203F, the second extension part 102F, and the contact part 103. Therefore, the return springs 11F to 14F can be manufactured easily and at a low cost.

Also in the return springs 11F to 14F of the seventh embodiment, only one of the cover parts 104F and 105F may be provided as in the first embodiment.

According to a first aspect of the embodiment described above, a return spring includes
a fixing part configured to be fixed to a friction pad,
a first extension part formed in a plate shape and extending from the fixing part in a direction away from the friction pad,
a second extension part formed in a plate shape and extending from the first extension part in a direction of pressing the friction pad,
a contact part formed in a plate shape and extending from the second extension part to come into contact with a carrier that is attached to a non-rotating portion of a vehicle,
edge portions that are surfaces each extending in a plate thickness direction of the first extension part, the second extension part, and the contact part, and
a cover part covering at least a part of the edge portions.

Thereby, maintainability of a disc brake in which the return spring is provided can be improved.

According to a second aspect, in the first aspect,
a connection part connecting the first extension part and the second extension part in a direction different from that of the first extension part and the second extension part is provided.

According to a third aspect, in the second aspect,
at least one of a first curved part provided in the first extension part to be connected to the connection part, and a second curved part provided in the second extension part to be connected to the connection part is provided.

According to a fourth aspect, in the first aspect,
the cover part is provided to extend from at least one of the first extension part, the second extension part, and the contact part.

According to a fifth aspect, in the third aspect,
the cover part is provided to extend from the intermediate plate part, and is provided at a position overlapping at least one of the first curved part and the second curved part in a plate thickness direction.

According to a sixth aspect, in the fifth aspect,
the cover part and the first curved part or the second curved part are provided with a predetermined distance therebetween.

According to a seventh aspect, in the first aspect,
the cover part is formed of a resin.

According to an eighth aspect, in the first aspect,
the cover part is formed of an elastic member.

According to a ninth aspect, in the first aspect,
the cover part is formed of a separate member from a return spring main body including the first extension part, the second extension part, and the contact part.

According to a tenth aspect, a disc brake includes
a friction pad, and
a return spring having a fixing part fixed to a friction pad, a first extension part formed in a plate shape and extending from the fixing part in a direction away from the friction pad, a second extension part formed in a plate shape and extending from the first extension part in a direction of pressing the friction pad, a contact part formed in a plate shape and extending from the second extension part to come into contact with a carrier that is attached to a non-rotating portion of a vehicle, edge portions that are surfaces each extending in a plate thickness direction of the first extension part, the second extension part, and the contact part, and a cover part covering at least a part of the edge portions. Thereby, maintainability of a disc brake can be improved.

### INDUSTRIAL APPLICABILITY

According to the above-described return spring and disc brake, it is possible to improve maintainability.

### REFERENCE SIGNS LIST

1 Disc brake
5 Carrier
8, 9 Friction pad
11, 11A to 11F Return spring
100 Fixing part
101, 101A, 101B, 101F First extension part
102, 102F, 102B, 102F Second extension part
103, 103B Contact part
104, 105, 222C, 222D, 222E, 104F, 105F Cover part
124 to 127, 124B, 125B, 124F, 125F, 134, 134F, 135, 135F, 145, 145B, 146, 146B, 211B to 216B Edge portion
131A Connection plate part (second curved part)
131F Second curved part
202A Intermediate plate part (first curved part)
202F First curved part
203A Distal end side extension plate part (connection part)
203F Connection part
221C Return spring main body

1. A return spring comprising:
a fixing part configured to be fixed to a friction pad;
a first extension part formed in a plate shape and extending from the fixing part in a direction away from the friction pad;
a second extension part formed in a plate shape and extending from the first extension part in a direction of pressing the friction pad;
a contact part formed in a plate shape and extending from the second extension part to come into contact with a carrier attached to a non-rotating portion of a vehicle;
edge portions which are surfaces each extending in a plate thickness direction of the first extension part, the second extension part, and the contact part; and
a cover part covering at least a part of the edge portions.

2. The return spring according to claim 1, wherein a connection part connecting the first extension part and the second extension part in a direction different from that of the first extension part and the second extension part is provided.

3. The return spring according to claim 2, wherein at least one of a first curved part provided in the first extension part to be connected to the connection part, and a second curved part provided in the second extension part to be connected to the connection part is provided.

4. The return spring according to claim 1, wherein the cover part is provided to extend from at least one of the first extension part, the second extension part, and the contact part.

5. The return spring according to claim 3, wherein the cover part is provided to extend from the connection part, and is provided at a position overlapping at least one of the first curved part and the second curved part in a plate thickness direction.

6. The return spring according to claim 5, wherein the cover part and the first curved part or the second curved part are provided with a predetermined distance therebetween.

7. The return spring according to claim 1, wherein the cover part is formed of a resin.

8. The return spring according to claim 1, wherein the cover part is formed of an elastic member.

9. The return spring according to claim 1, wherein the cover part is formed of a separate member from a return spring main body including the first extension part, the second extension part, and the contact part.

10. A disc brake comprising:
a friction pad; and
a return spring including:
a fixing part fixed to a friction pad;
a first extension part formed in a plate shape and extending from the fixing part in a direction away from the friction pad;
a second extension part formed in a plate shape and extending from the first extension part in a direction of pressing the friction pad;
a contact part formed in a plate shape and extending from the second extension part to come into contact with a carrier attached to a non-rotating portion of a vehicle;
edge portions which are surfaces each extending in a plate thickness direction of the first extension part, the second extension part, and the contact part; and
a cover part covering at least a part of the edge portions.
